(19) United States
(12) Patent Application Publication
(10) Pub. No.: US 2019/0207349 A1
(43) Pub. Date: Jul. 4, 2019

(54) POWER SUPPLY CONNECTOR ASSEMBLIES

(71) Applicant: Apple Inc., Cupertino, CA (US)

(72) Inventors: Paul Z. Yuan, San Jose, CA (US); Min Chul Kim, San Jose, CA (US); Xuan Liu, Cupertino, CA (US)

(21) Appl. No.: 16/146,511

(22) Filed: Sep. 28, 2018

Related U.S. Application Data
(60) Provisional application No. 62/611,192, filed on Dec. 28, 2017.

(51) Int. Cl. H01R 31/06; H01R 13/508; H01R 13/631; H01R 13/42

(52) U.S. Cl. CPC H01R 31/06; H01R 13/42; H01R 13/631; H01R 13/508

(57) ABSTRACT

Power supply connector assemblies and methods for making the same are provided. An outer housing of the power supply connector assembly may include a unibody five-sided box-like structure and a set of power supply connector contacts may extend out therefrom for coupling to an electric power supply, while other portions of the set of power supply connector contacts may be electrically coupled to portions of a set of power adapter connector contacts within the outer housing. A protection body (e.g., a plastic insulation structure) may be positioned inside the outer housing for preventing user exposure to one or more live contacts of the power supply connector contacts when a portion of the outer housing is damaged or removed during a system break event.

### CROSS-REFERENCE TO RELATED APPLICATION(S)

This application claims the benefit of prior filed U.S. Provisional Patent Application No. 62/611,192, filed Dec. 28, 2017, which is hereby incorporated by reference herein in its entirety.

### TECHNICAL FIELD

This disclosure relates to power supply connector assemblies and, more particularly, to power supply connector assemblies with protected contacts.

### BACKGROUND OF THE DISCLOSURE

Conventional power supply connector assemblies used for electrically coupling power adapter assemblies to electric power supplies are often susceptible to break events that expose live electrical contacts. Accordingly, alternative power supply connector assemblies are needed.

### SUMMARY OF THE DISCLOSURE

Power supply connector assemblies and methods for making the same are provided.

For example, in some embodiments, an assembly may be provided for being electrically coupled to a power supply contact of a power supply and to a power adapter contact of a power adapter. The assembly may include an outer case defining an interior space, wherein the outer case may include a top wall, a bottom wall, a left wall, a right wall, a front wall, and an open end. The assembly may also include a power supply connector including a power supply connector contact including a power supply contact portion operative to be electrically coupled to the power supply contact of the power supply, and a power adapter connector contact portion positioned within the interior space. The assembly may also include a power adapter connector including a power adapter connector body defining a contact passageway and operative to be held with respect to the outer case, wherein, when the power adapter connector body is held with respect to the outer case, a portion of the power adapter connector body may be positioned within the open end of the outer case, and a power adapter connector contact at least partially positioned within the contact passageway and including a power adapter contact portion operative to be electrically coupled to the power adapter contact of the power adapter, and a power supply connector contact portion, wherein, when the power adapter connector body is held with respect to the outer case, the power supply connector contact portion may be electrically coupled to the power adapter connector contact portion within the interior space.

As another example, in some embodiments, an assembly may be provided for being electrically coupled to a power supply contact of a power supply and to a power adapter contact of a power adapter. The assembly may include an outer case defining an interior space. The assembly may also include a power supply connector including a power supply connector contact including a power supply contact portion operative to be electrically coupled to the power supply contact of the power supply, and a power adapter connector contact portion positioned within the interior space. The assembly may also include a power adapter connector including a power adapter connector body defining a contact passageway and operative to be held with respect to the outer case, and a power adapter connector contact at least partially positioned within the contact passageway and including a power adapter contact portion operative to be electrically coupled to the power adapter contact of the power adapter, and a power supply connector contact portion, wherein, when the power adapter connector body is held with respect to the outer case, the power supply connector contact portion may be electrically coupled to the power adapter connector contact portion within the interior space, structure within the interior space may define at least a portion of a recess guide extending between a first recess guide end and a second recess guide end within the interior space, the power adapter connector contact portion may be positioned within the interior space adjacent the second recess guide end of the recess guide, and the recess guide may be operative to prevent a user of the assembly from directly contacting the power adapter connector contact portion of the power supply connector contact positioned within the interior space.

As yet another example, in some embodiments, an assembly may be provided for being electrically coupled to a power supply contact of a power supply and to a power adapter contact of a power adapter. The assembly may include an outer case defining an interior space. The assembly may also include a power supply connector including a power supply connector contact that may include a power supply contact portion operative to be electrically coupled to the power supply contact of the power supply and a power adapter connector contact portion positioned within the interior space. The assembly may also include a power adapter connector including a power adapter connector body that may define a contact passageway, include a contact retention feature external to the contact passageway, and be operative to be held with respect to the outer case, and a power adapter connector contact at least partially positioned within the contact passageway and including a power adapter contact portion operative to be electrically coupled to the power adapter contact of the power adapter, a power supply connector contact portion that is electrically coupled to the power adapter connector contact portion within the interior space when the power adapter connector body is held with respect to the outer case, and a power adapter connector contact body held by the contact retention feature for maintain the position of the power adapter connector contact at least partially within the contact passageway when the power adapter connector body is pulled away from the interior space while the power supply connector contact portion is electrically coupled to the power adapter connector contact portion within the interior space.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1A is a perspective view of an illustrative power adapter system that includes a power supply connector assembly and a power adapter assembly being used to electrically couple an electric power supply to an electronic device;

FIG. 1B is a perspective view of the power adapter system of FIG. 1A but with an additional interchangeable power supply connector assembly;

FIG. 1C is a top view of the power adapter system of FIGS. 1A and 1B;

FIG. 1D is a perspective view of the power adapter system of FIGS. 1A-1C that includes the additional interchangeable power supply connector assembly and the power adapter assembly being used to electrically couple an electric power supply to an electronic device;

FIG. 2 is a perspective view of the power adapter assembly of FIGS. 1A-1D;

FIG. 3 is a perspective view of the power supply connector assembly of FIGS. 1A-1C in a first stage of assembly;

FIG. 4 is a perspective view of the power supply connector assembly of FIGS. 1A-1C and 3 in a second stage of assembly;

FIGS. 5-7 are perspective views of the power supply connector assembly of FIGS. 1A-1C, 3, and 4 in a third stage of assembly;

FIG. 8 is a perspective view of the power supply connector assembly of FIGS. 1A-1C and 3-7 in a fourth stage of assembly;

FIGS. 9 and 10 are perspective views of the power supply connector assembly of FIGS. 1A-1C and 3-8 in a fifth stage of assembly;

FIG. 11 is a perspective view of the power supply connector assembly of FIGS. 1A-1C and 3-10 in a sixth stage of assembly;

FIG. 12 is a perspective view of the power supply connector assembly of FIGS. 1A-1C and 3-11 in a seventh stage of assembly;

FIG. 13 is a perspective view of the power supply connector assembly of FIGS. 1A-1C and 3-12 in an eighth stage of assembly;

FIGS. 14-16 are perspective views of the power supply connector assembly of FIGS. 1A-1C and 3-13 in a ninth stage of assembly;

FIGS. 17-19 are perspective views of the power supply connector assembly of FIGS. 1A-1C and 3-16 in a tenth stage of assembly;

FIG. 20 is a perspective view of the power supply connector assembly of FIGS. 1A-1C and 3-19 in an eleventh stage of assembly, with power supply connector contacts in an open position;

FIG. 21 is a perspective view of the power supply connector assembly of FIGS. 1A-1C and 3-20 in the eleventh stage of assembly, but with the power supply connector contacts in a closed position;

FIGS. 22 and 23 are perspective views of the power supply connector assembly of FIGS. 1A-1C and 3-21 in the tenth stage of assembly, but with certain portions of the assembly not shown;

FIG. 24 is a perspective view of the power supply connector assembly of FIGS. 1A-1C and 3-23 in the eleventh stage of assembly, but with certain portions of the assembly not shown;

FIG. 25 is a rear view of the power supply connector assembly of FIGS. 1A-1C and 3-23 in the eleventh stage of assembly, but with certain portions of the assembly not shown;

FIG. 26 shows perspective views of distinct outer shell structures of an outer shell of the power supply connector assembly of FIGS. 1A-1C and 3-25, but with some interior wall features not shown;

FIG. 27 is a perspective view of the outer shell of the power supply connector assembly of FIGS. 1A-1C and 3-26, but with some interior wall features not shown;

FIG. 28 is a perspective view of a cross-section of the outer shell of the power supply connector assembly of FIGS. 1A-1C and 3-27;

FIG. 29 is a perspective view of a cross-section of the power supply connector assembly of FIGS. 1,A-1C and 3-28 in a stage similar to the tenth stage of assembly, with the power supply connector contacts in each one of the closed position, the open position, and an intermediate transition position;

FIG. 30 is a rear view of a portion of the power supply connector assembly of FIGS. 1A-1C and 3-29 in any one of the fifth, sixth, seventh, eighth, ninth, or tenth stage of assembly, with the power supply connector contacts in the open position;

FIG. 31 is a rear view of the power adapter system of FIGS. 1A-1D that includes the power supply connector assembly of FIGS. 1A-1C and 3-30 in the eleventh stage of assembly, with the power supply connector contacts in the closed position, mated with the power adapter assembly of FIGS. 1A-2;

FIG. 32 is a cross-sectional view of the power adapter system of FIGS. 1A-1D and 31, taken from line XXXII-XXXI of FIG. 31;

FIG. 33 is a perspective view of a gap spring of the power supply connector assembly of FIGS. 1A-1C and 3-32;

FIG. 34 is a rear view of the gap spring of FIG. 33;

FIG. 35 is a side view of the gap spring of FIGS. 33 and 34;

FIG. 36 is a side cross-sectional view of the power supply connector assembly of FIGS. 1A-1C and 3-32 in the eleventh stage of assembly, with the power supply connector contacts in each one of the closed position, the open position, and the intermediate transition position, and with a prong spring in an open position, but with some interior features not shown;

FIG. 37 is a side cross-sectional view of the power supply connector assembly of FIGS. 1A-1C, 3-32, and 36 in the eleventh stage of assembly, with the power supply connector contacts in each one of the closed position, the open position, and the intermediate transition position, and with the prong spring in an intermediate position, but with some interior features not shown;

FIG. 38 is a side view of an alternative prong spring;

FIG. 39 is a side view of the prong spring of the power supply connector assembly of FIGS. 1A-1C, 3-32, 36, and 37;

FIGS. 40 and 41 are perspective views of the prong spring of FIGS. 36, 37, and 39;

FIG. 42 is a side view of the prong spring of FIGS. 36, 37, and 39-41;

FIG. 43 is a top view of the prong spring of FIGS. 36, 37, and 39-42;

FIG. 44 is a rear view of the power supply connector contacts and a prong bridge of the power supply connector assembly of FIGS. 1A-1C, 3-32, 36, and 37;

FIG. 45 is a side view of the power supply connector contacts and the prong bridge of FIG. 44, taken from line XLV-XLV of FIG. 44;

FIG. 46 is a bottom view of the power supply connector contacts and the prong bridge of FIGS. 44 and 45, taken from line XLVI-XLVI of FIG. 44;

FIG. 47 is a cross-sectional view of the power supply connector contacts and the prong bridge of FIGS. 44-46, taken from line XLVII-XLVII of FIG. 46; and

FIG. 48 is a cross-sectional view of the power supply connector contacts and the prong bridge of FIGS. 44-47, taken from line XLVIII-XLVIII of FIG. 46.

### DETAILED DESCRIPTION OF THE DISCLOSURE

Power supply connector assemblies for power adapter systems and methods for making the same may be provided to reduce the risk of user exposure to live electrical contacts of the power supply connector assemblies during break events between portions of the power supply connector assemblies. A power adapter system may include a power adapter assembly for adapting and providing particular power to a user electronic device, and two or more interchangeable power supply connector assemblies for electrically coupling the power adapter assembly to an electric power supply. Due to the fact that an electrical connection between the power adapter assembly and an interchangeable power supply connector assembly of such a power adapter system may not be fixed but instead may be routinely terminated, one or more undesirable break events between portions of the system may be possible during use of the system. An outer housing of the power supply connector assembly may include a unibody five-sided box-like structure (e.g., as a result of a single or multi-shot (e.g., sequential injection) or multi-component (e.g., co-injection) molding process or as a result of an over-molding process), such as a unibody outer case with a top wall, a bottom wall, a front wall, a left wall, and a right wall (e.g., a case with an open end (e.g., a case without a back wall)). A set of power supply connector contacts may extend out from such a five-sided box-like structure or outer case for coupling to an electric power supply, while other portions of the set of power supply connector contacts may be electrically coupled to portions of a set of power adapter connector contacts within the outer housing. A protection body (e.g., a plastic insulation structure) may be positioned inside the outer housing for preventing user exposure to one or more live contacts of the power supply connector contacts when a portion of the outer housing is damaged or removed during a system break event. Moreover, the protection body may support a prong spring within the outer housing that may be operative to interact with one or more components physically coupled to each power supply connector contact for enabling rotation of the power supply connector contacts between a first stable open position for coupling the contacts to an electric power supply and a second closed stable position for compactly storing the power supply connector assembly. An adapter connector body may be fixed to the power adapter connector contacts and may provide a cap wall for mating with the outer case (e.g., five-sided box-like structure) of the outer housing to complete the outer housing, and portions of the power adapter connector contacts may extend through the protection body for electrically coupling with the power supply connector contacts within the completed outer housing. When the adapter connector body may be pulled from the remainder of the outer housing during a break event, it may pull the power adapter connector contacts along with it, thereby electrically decoupling the power adapter connector contacts from the live power supply connector contacts. A slot may be provided through one of the five walls of the five-sided box-like structure such that a connector mating structure of the power adapter assembly may be introduced into an interior space defined by the five-sided box-like structure for physically coupling the power adapter assembly to the power supply connector assembly. A spring may be positioned within that interior space about at least a portion of that slot for pulling an exterior surface of the five-sided box-like structure against an exterior surface of the power adapter assembly from which the connector mating structure may extend.

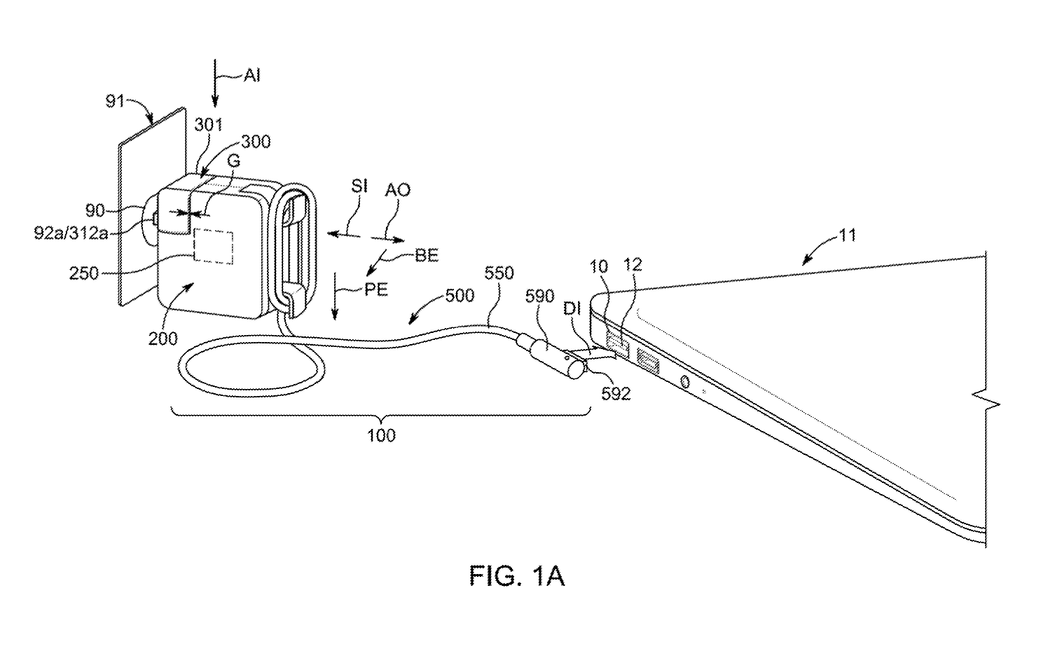

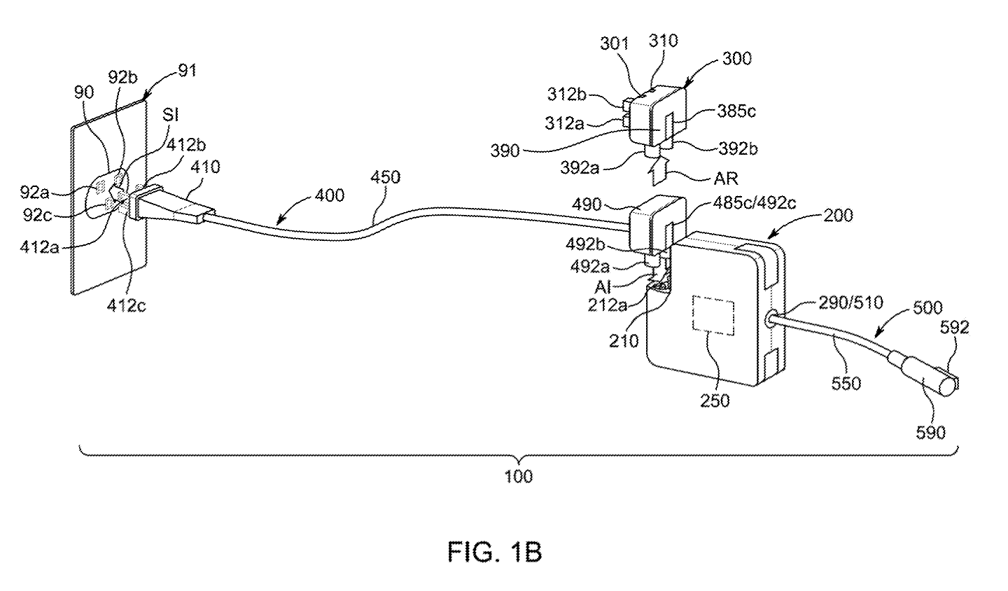

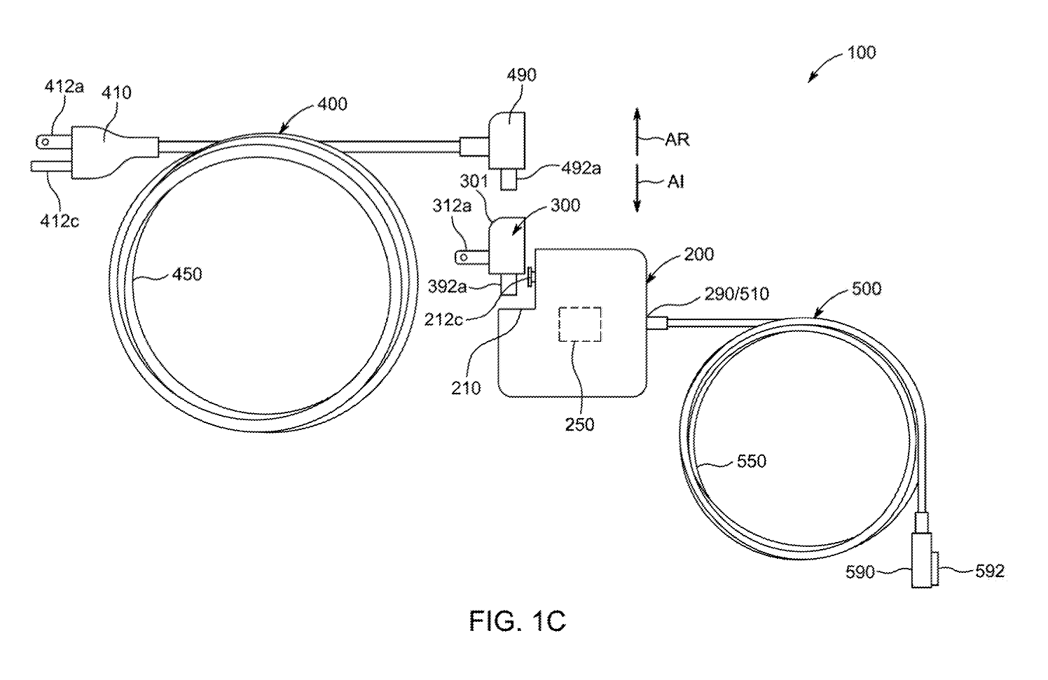

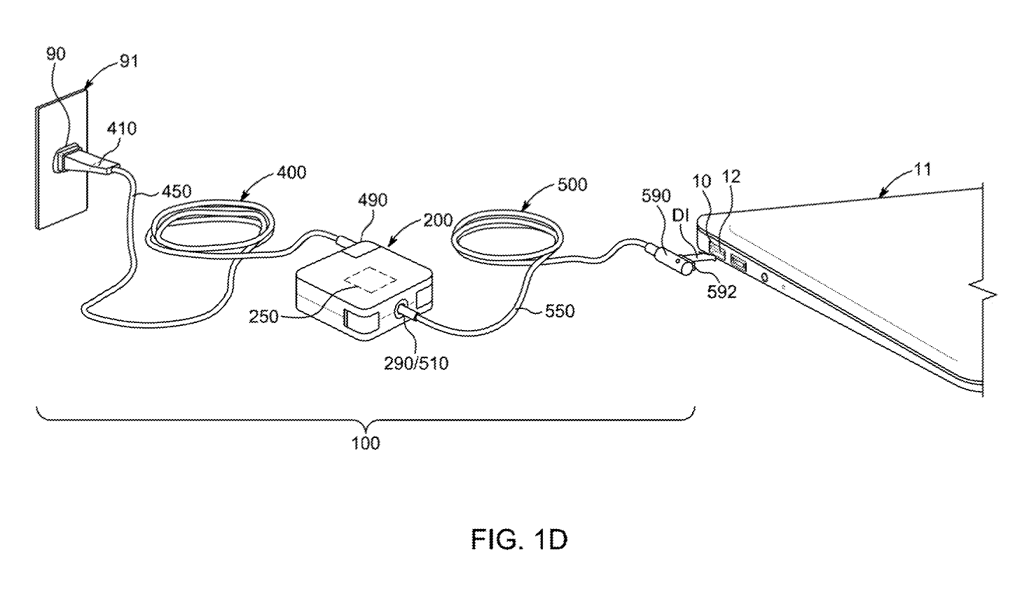

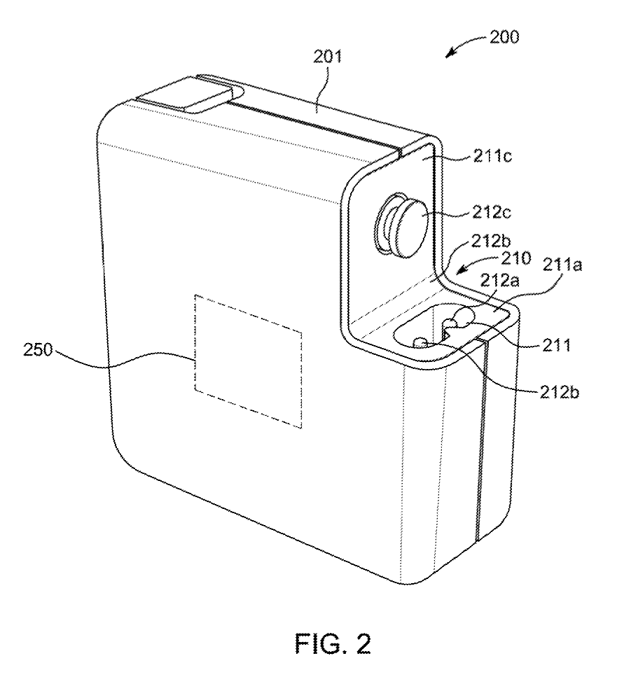

As shown in FIGS. 1A-2, a power adapter system 100 may include a power adapter assembly 200 that may be operative to receive any suitable input electric power from a socket connector 90 of an electric power supply 91 via either one of interchangeable power supply connector assemblies 300 and 400, to derive any suitable output electric power from the received input electric power using any suitable adapter circuitry 250 of power adapter assembly 200, and then to deliver the derived output electric power to a device power connector 10 of an electronic device 11 via a device connector assembly 500. For example, adapter circuitry 250 may include any suitable circuitry that may be operative to derive a required voltage and power for electronic device 11 from mains power provided by electric power supply 91. Power adapter system 100 may be used for providing power to any suitable electronic device 11, which may include no internal source of power or that may include an internal source of power (e.g., a battery) that may be charged while the device is also being powered by power adapter system 100. Electronic device 11 can require any suitable voltage and/or power and may include, but is not limited to, a media player, video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop (e.g., a MacBook™ available by Apple Inc.), tablet (e.g., an iPad™ available by Apple Inc.), server, etc.), monitor, television, stereo equipment, set up box, set-top box, boom box, modem, router, printer, watch, biometric monitor, or any combination thereof. Device power connector 10 may be any suitable connector type of any suitable electronic device 11 for receiving any suitable power from power adapter system 100, where device power connector 10 may include any suitable number of device power connector contacts 12 that may be operative to be electrically coupled to any suitable number of device power connector contacts 592 of any suitable device power connector 590 of device connector assembly 500 (e.g., when a portion of device power connector 590 is mated with device power connector 10 in the direction of arrow DI of FIGS. 1A and 1D.

Power adapter assembly 200 may include any suitable adapter power connector 210 that may be operative to be electrically coupled to any suitable power adapter connector of either one of interchangeable power supply connector assemblies 300 and 400, any suitable adapter device connector 290 that may be operative to be electrically coupled to any suitable device adapter connector of device connector assembly 500, and any suitable adapter circuitry 250 that may be operative to adapt any input electric power received at adapter power connector 210 into output electric power provided at adapter device connector 290. Adapter power connector 210 may include any suitable number of adapter power connector contacts, such as a first or neutral adapter power connector contact 212a, a second or hot adapter power connector contact 212b, and a third or ground adapter power connector contact 212c, where each adapter power connector contact may be electrically coupled to an input of adapter circuitry 250 (not shown) and also at least partially accessible for electrically coupling to a respective power adapter connector contact of a power adapter connector of either one of interchangeable power supply connector assemblies 300 and 400, such that one or more of the adapter power connector contacts may be operative to provide any power received from either one of interchangeable power supply connector assemblies 300 and 400 to adapter circuitry 250 for adaptation.

Power adapter assembly 200 may include a power adapter housing 201 of any suitable shape that may at least partially enclose one or more of the components of power adapter assembly 200 (e.g., adapter circuitry 250) for protection from debris and other degrading forces external to power adapter assembly 200 and/or for protecting a user from hot or otherwise potentially harmful components internal to housing 201. For example, as shown, housing 201 may be substantially shaped like the exterior of a rectangular cuboid with rounded edges for providing a cosmetic exterior for a significant portion of assembly 200, while a cut out section may be provided that may make each adapter power connector contact of adapter power connector 210 accessible for electrical coupling with a respective power adapter connector contact of a power adapter connector of either one of interchangeable power supply connector assemblies 300 and 400. In a particular example shown in FIG. 2, each one of adapter power connector contacts 212a and 212b may be at least partially exposed (e.g., as an electrically conductive pin) within an inlet 211 (e.g., a connector mating structure) provided through a first exterior surface 211a of the cut out section (e.g., as a C8B inlet type of the IEC 60320 coupler standard by the International Electrotechnical Commission (“IEC”)), while adapter power connector contact 212c may be a protruding (e.g., mushroom head-shaped) contact (e.g., a connector mating structure) that extends out and away from a second exterior surface 211c of the cut out section, which may form any suitable angle with first exterior surface 211a at an edge 211b (e.g., a 90° angle). It is to be understood that adapter power connector 210 may include any other suitable number of adapter power connector contacts of any suitable type and relative position with respect to a shape of housing 201. In some embodiments, contact 212c may not be electrically coupled to adapter circuitry 250 but instead may just be used as a connector mating structure (e.g., to interact with a slot 385c of assembly 300 and/or a slot 485c of assembly 400).

In addition to one or more device power connector contacts 592 of device power connector 590 for electrically coupling to a respective device power connector contact 12 of device power connector 10 of electronic device 11, device connector assembly 500 may also include any suitable device adapter connector 510 that may be operative to be electrically coupled to adapter device connector 290 of power adapter assembly 200. For example, adapter device connector 290 may include any suitable number of adapter device connector contacts (not shown), where each adapter device connector contact may be electrically coupled to an output of adapter circuitry 250 (not shown) and also electrically coupled to a respective device adapter connector contact (not shown) of device adapter connector 510, such that one or more of the adapter device connector contacts of adapter device connector 290 may be operative to provide any power received from adapter circuitry 250 to a respective device adapter connector contact of device adapter connector 510. Moreover, in some embodiments, as shown, device connector assembly 500 may also include any suitable device power cord 550 of any suitable length and with any suitable number of electrically conductive conductors or conductor bundles (not shown), each of which may be operative to electrically couple a respective device adapter connector contact of device adapter connector 510 to a respective device power connector contact 592 of device power connector 590. Alternatively, a respective device adapter connector contact of device adapter connector 510 may be directly electrically connected to a respective device power connector contact 592 of device power connector 590. Therefore, device connector assembly 500 may be operative to provide any suitable power received from any adapter device connector contact of adapter device connector 290 at any respective device adapter connector contact of device adapter connector 510 (e.g., any suitable output electric power provided to adapter device connector 290 by adapter circuitry 250) to any respective device power connector contact 12 of device power connector 10 of electronic device 11 via device power cord 550 and any respective device power connector contact 592 of device power connector 590. As shown in FIGS. 1A-2, device connector assembly 500 may be permanently fixed to power adapter assembly 200 (e.g., the contacts of device adapter connector 510 may be permanently fixed to the contacts of adapter device connector 290). Alternatively, connector 510 may be any suitable type of connector that may be operative to be releasably or removably coupled to connector 290. Alternatively, device connector assembly 500 may not include a cord 550 or a connector 510, but, instead, connector 590 may be permanently fixed to or releasably or removably coupled to connector 290 for reducing that path between connector 290 and connector 10.

Electric power supply 91 may be any suitable power supply for providing any suitable power to power adapter system 100 (e.g., mains electric power from a general-purpose alternating-current (“AC”) electric power supply). Socket connector 90 may be any suitable type (e.g., a NEMA 5-15R receptacle) with any suitable number of socket connector contacts, such as a first or neutral socket connector contact 92a, a second or hot socket connector contact 92b, and a third or ground socket connector contact 92c, for being electrically coupled to different connector contacts of power supply connector assembly 300 or of power supply connector assembly 400.

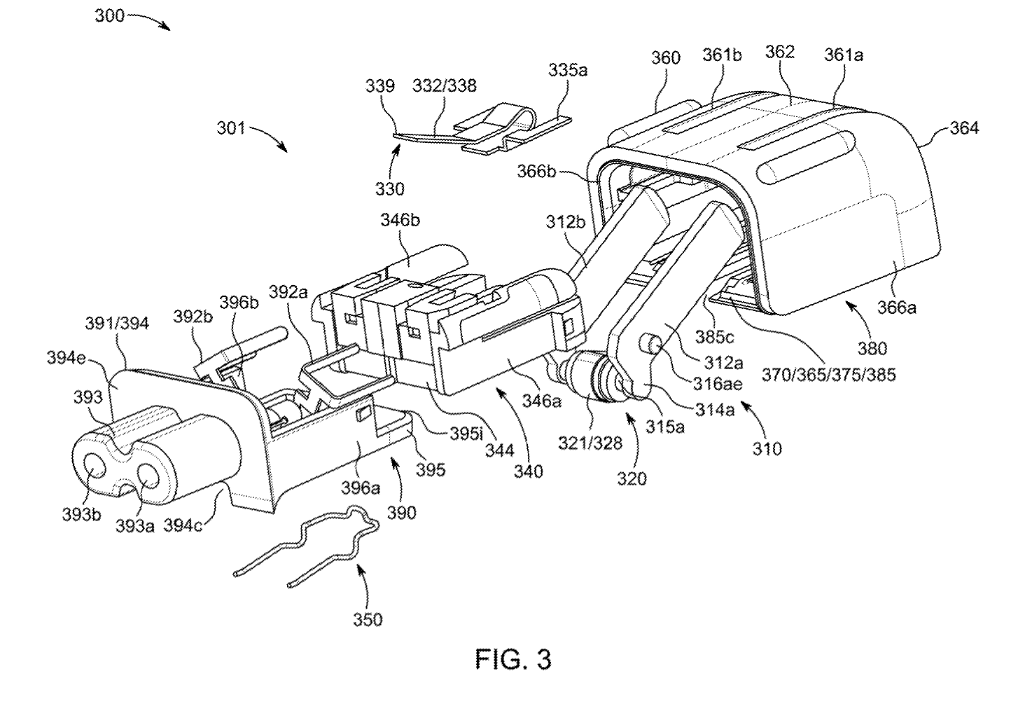

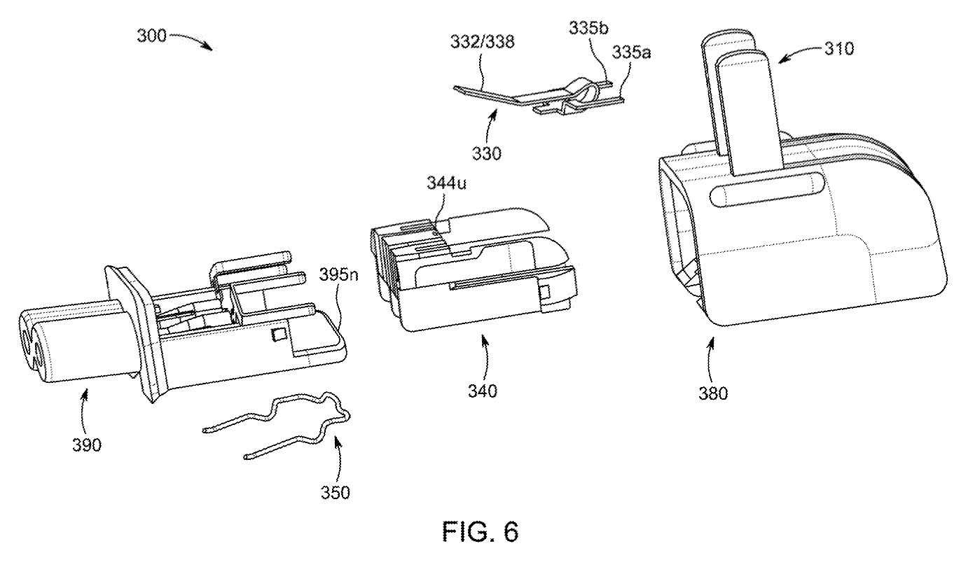

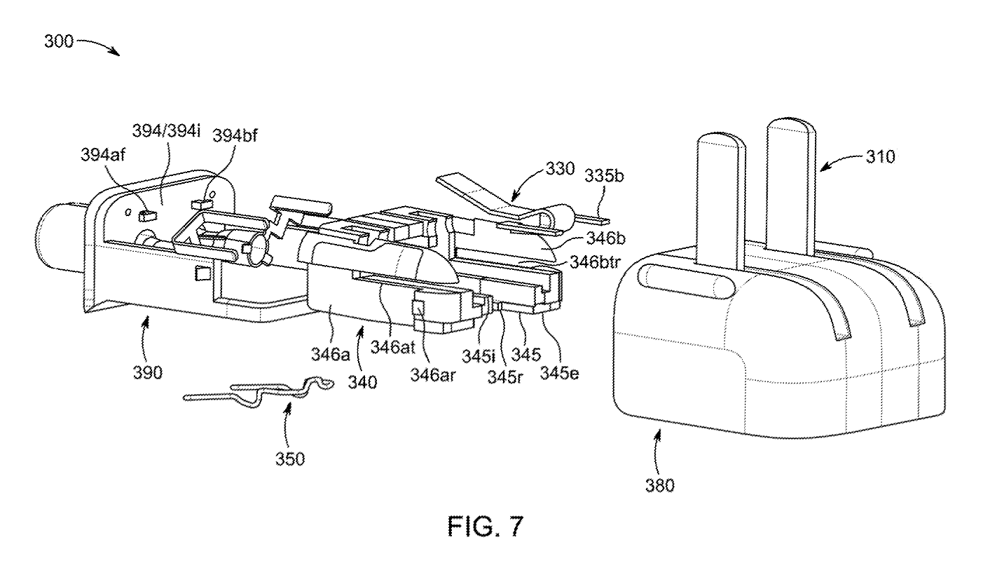

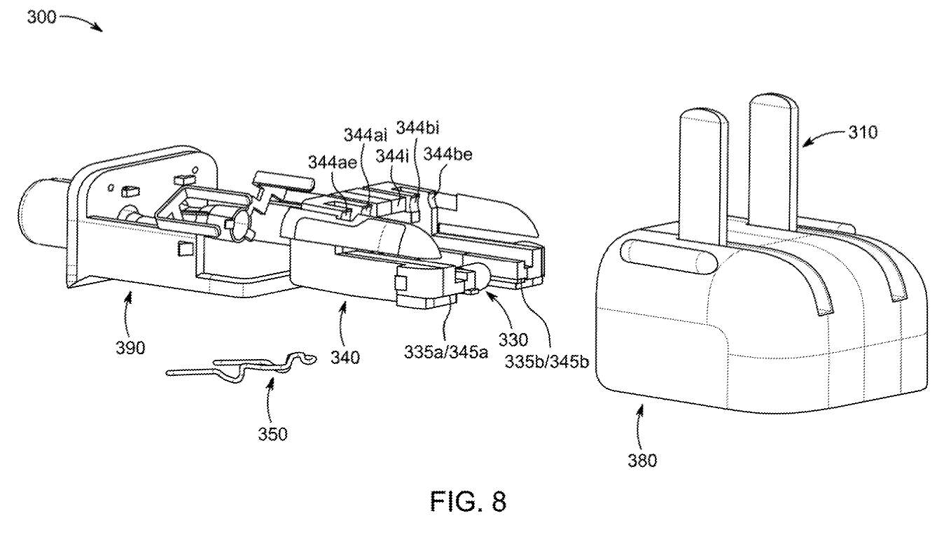

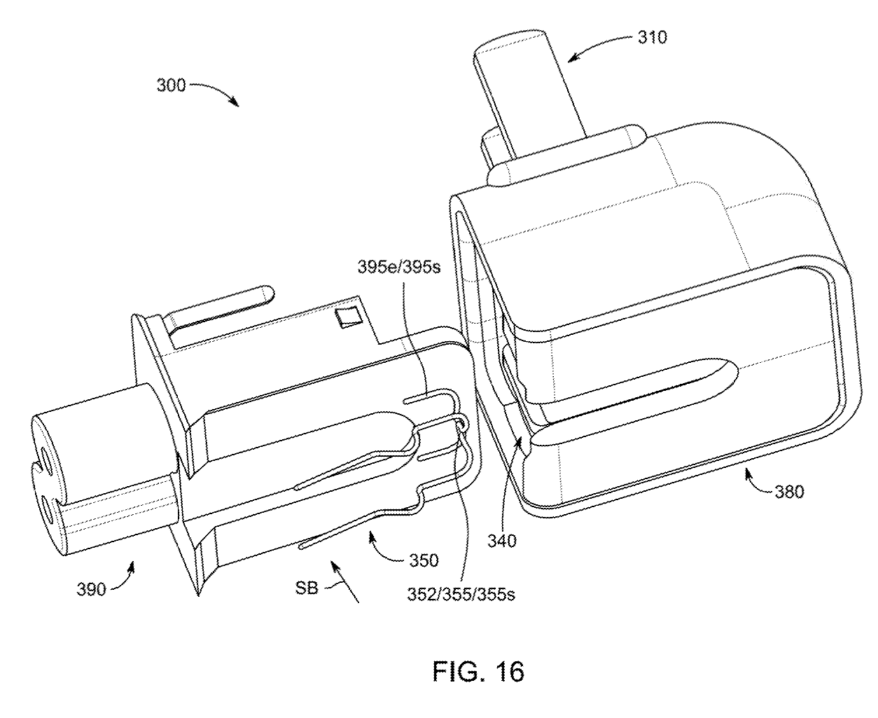

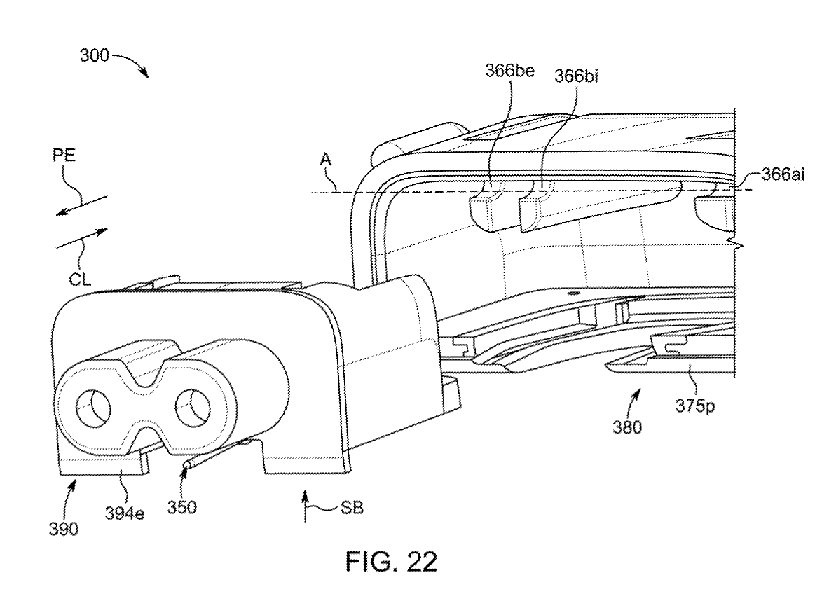

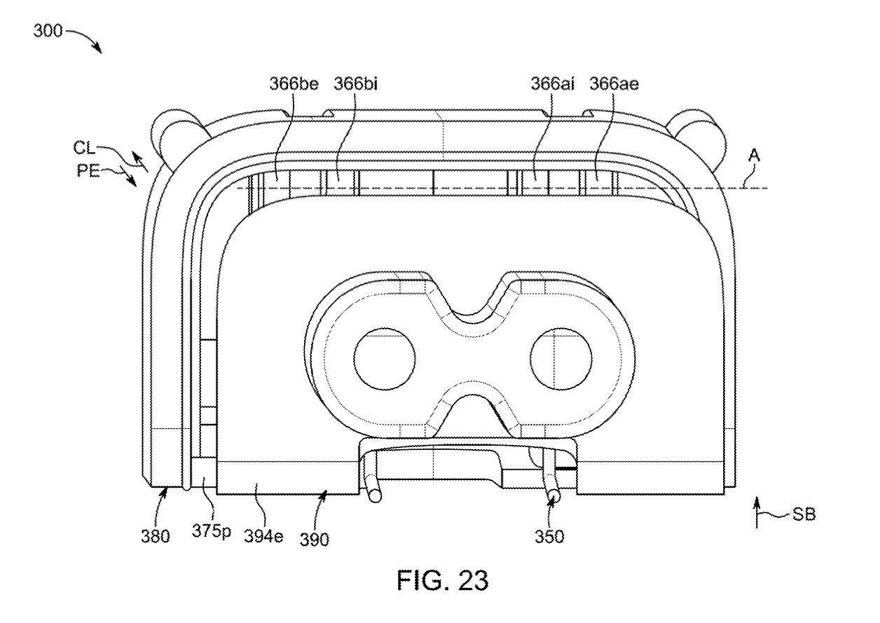

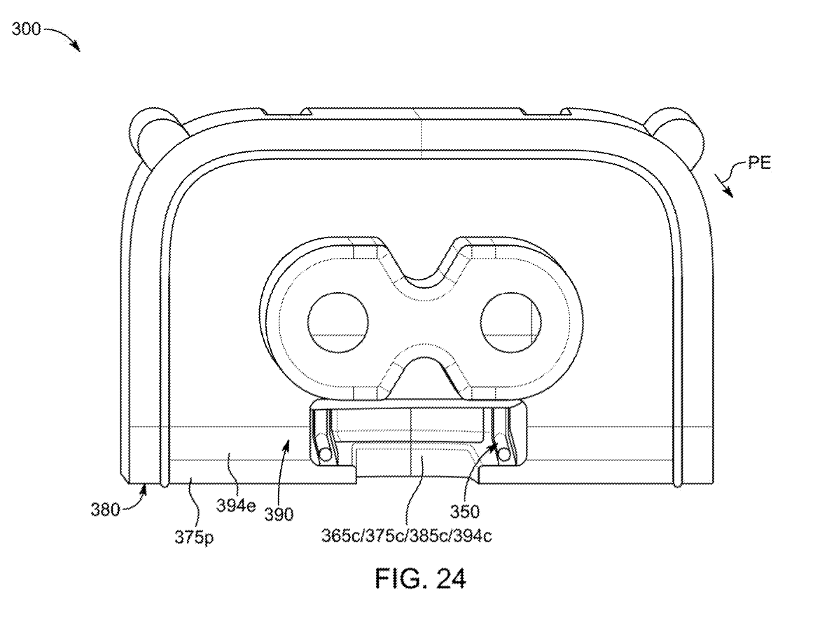

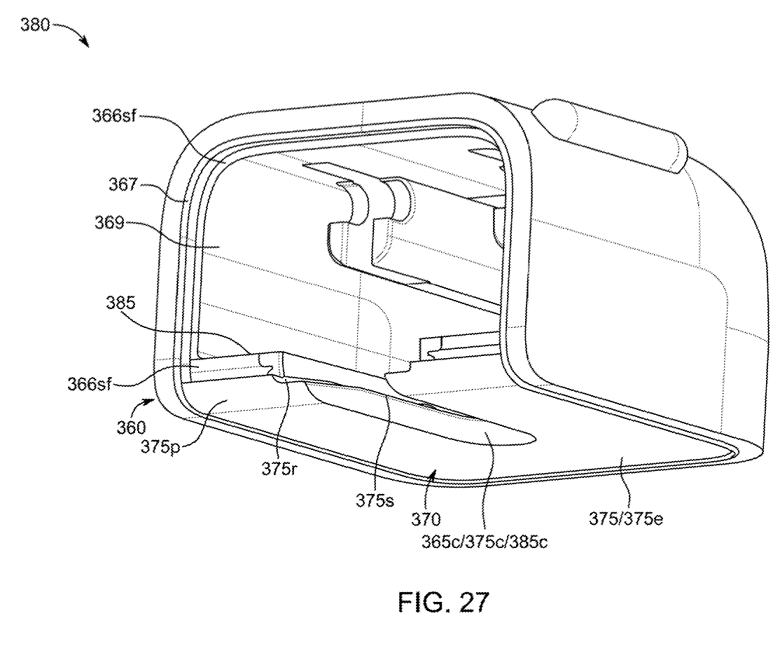

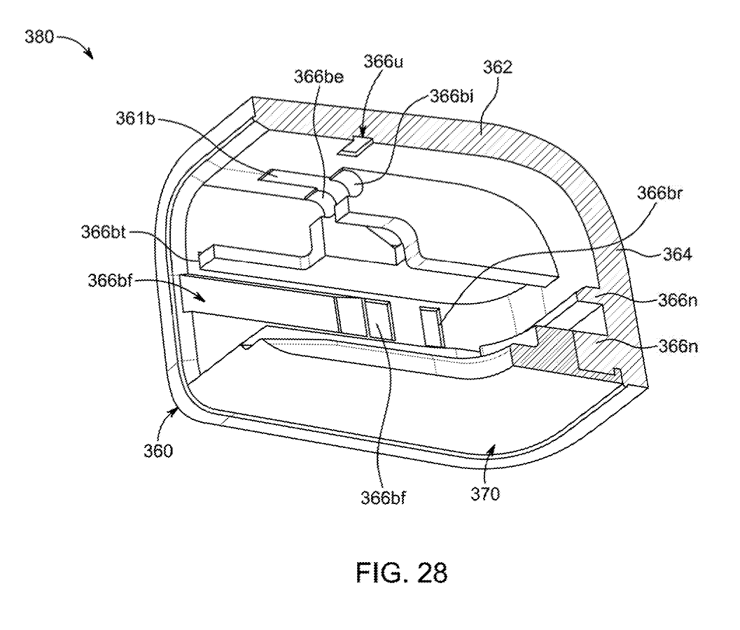

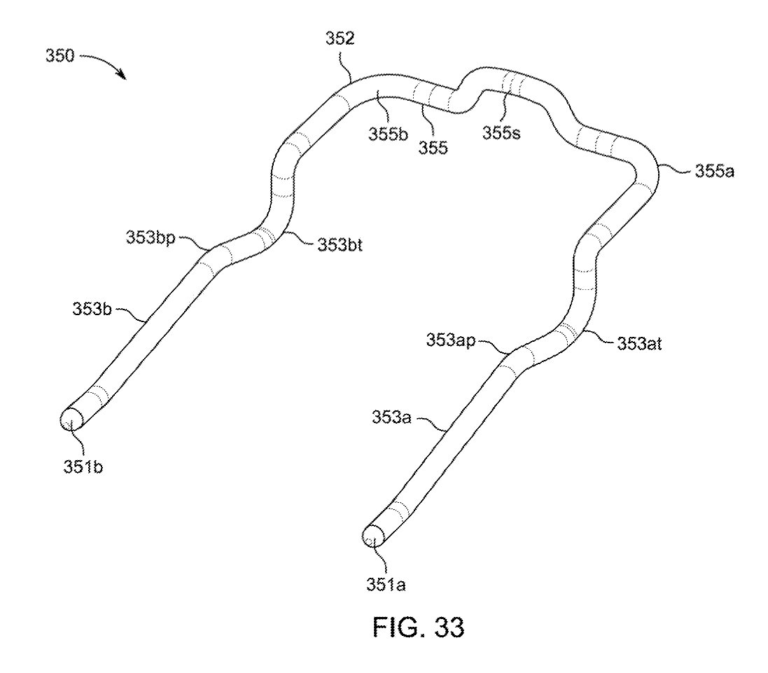

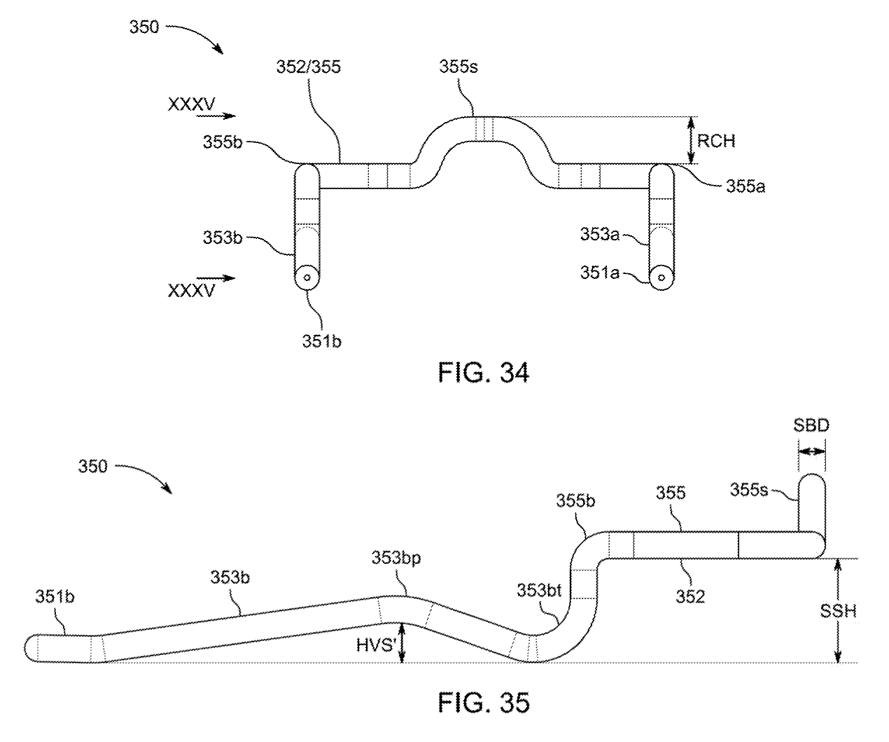

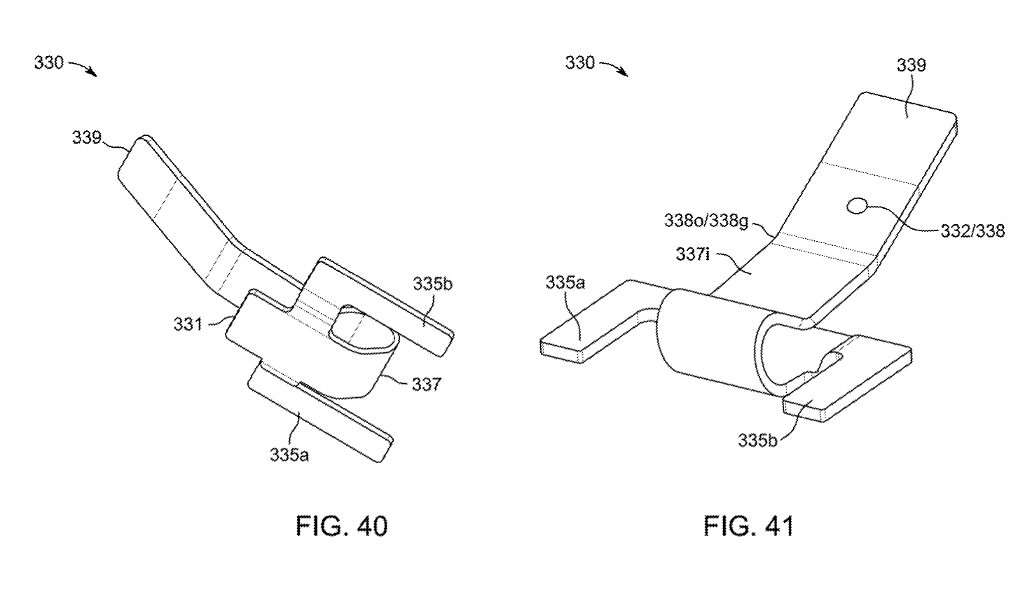

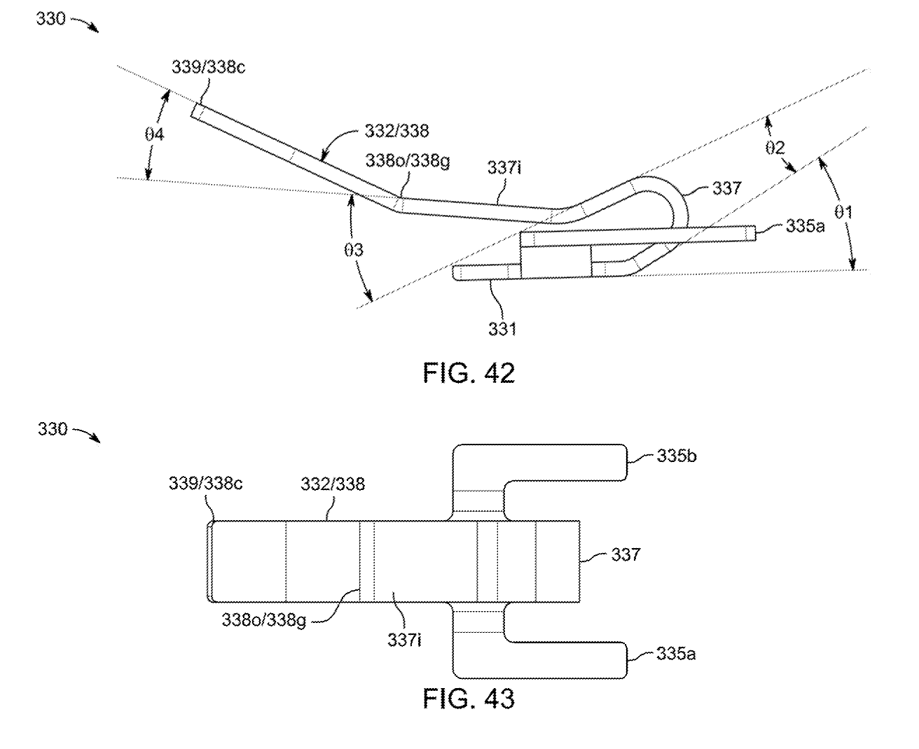

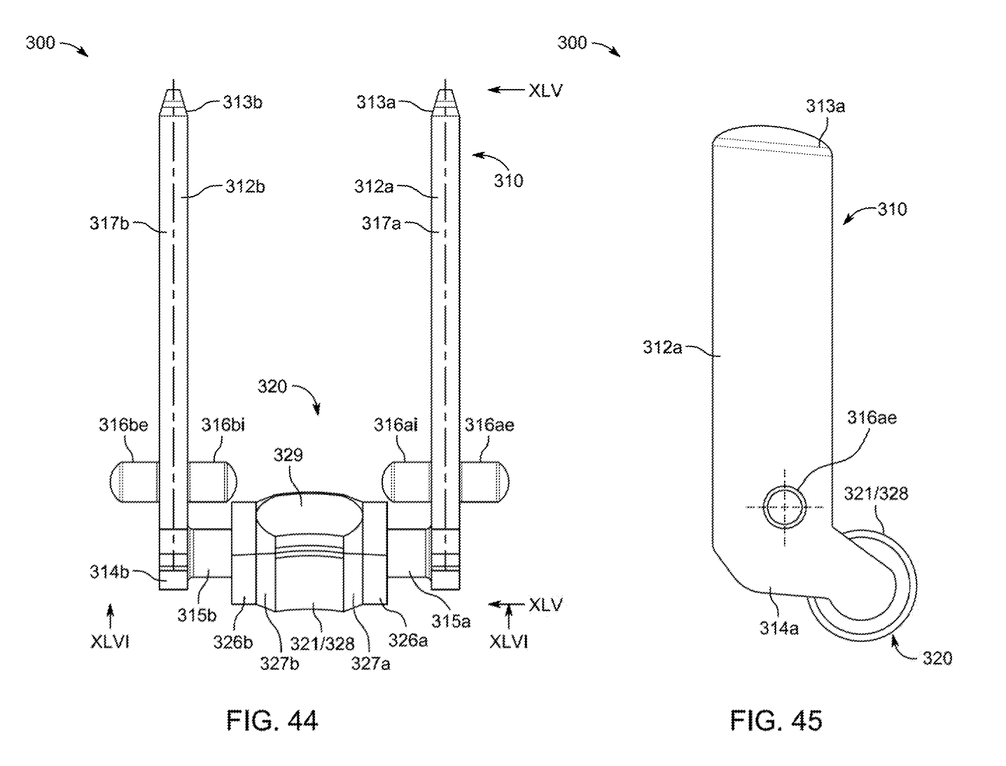

Power supply connector assembly 300 may be a cordless power supply connector assembly that may include a cordless power supply connector 310 operative to be electrically connected to socket connector 90 of electric power supply 91, a cordless power adapter connector 390 operative to be electrically connected to adapter power connector 210 of power adapter assembly 200, and a cordless power connector housing 301 operative not only to protect at least a portion of each one of connectors 310 and 390 but also to protect an electrical coupling between connectors 310 and 390. Cordless power supply connector 310 may include any suitable type of connector (e.g., a 2-prong NEMA 1-15 AC plug) with any suitable number of cordless power supply connector contacts, such as a first or neutral cordless power supply connector contact 312a and a second or hot cordless power supply connector contact 312b for being electrically coupled to different socket connector contacts of socket connector 90 (e.g., as shown in FIG. 1A, contact 312a may be electrically coupled to (e.g., retained within) contact 92a and contact 312b may be electrically coupled to (e.g., retained within) contact 92b, for example, when connector 310 is mated with connector 90 in the insertion direction of arrow SI). Moreover, cordless power adapter connector 390 may include any suitable type of connector (e.g., a C7 or figure 8 or shotgun connector of the IEC 60320 coupler standard) with any suitable number of cordless power adapter connector contacts, such as a first or neutral cordless power adapter connector contact 392a and a second or hot cordless power adapter connector contact 392b, for being electrically coupled to different adapter power connector contacts of adapter power connector 210 (e.g., contact 392a may be electrically coupled to (e.g., retained about) contact 212a (e.g., within inlet 211) and contact 392b may be electrically coupled to (e.g., retained about) contact 212b (e.g., within inlet 211) and a slot 385c may be physically coupled to (e.g., held about) contact 212c, for example, when connector 390 is mated with connector 210 in the insertion direction of arrow AI). As described in more detail with respect to FIGS. 3-48, each power supply connector contact of cordless power supply connector 310 may be electrically coupled to a respective power adapter connector contact of cordless power adapter connector 390 (e.g., contact 312a may be electrically coupled to contact 392a, and contact 312h may be electrically coupled to contact 392b), such that cordless power supply connector assembly 300 may be operative to electrically couple a respective socket connector contact of socket connector 90 to a respective adapter power connector contact of adapter power connector 210 (e.g., contact 92a may be electrically coupled to contact 212a, and contact 92b may be electrically coupled to contact 212b) when connector 310 is electrically coupled to connector 90 and connector 390 is simultaneously electrically coupled to connector 210 (e.g., as shown in FIG. 1A). Cordless power connector housing 301 may not only protect at least a portion of each power supply connector contact of power supply connector 310 and at least a portion of each power adapter connector contact of power adapter connector 390, but also housing 301 may protect an electrical coupling between each power supply connector contact and a respective power adapter connector contact (e.g., housing 301 may protect a first electrical coupling between contact 312a and contact 392a as well as a second electrical coupling between contact 312b and contact 392b).

Power supply connector assembly 400 may be a corded power supply connector assembly that may include a corded power supply connector 410 operative to be electrically connected to socket connector 90 of electric power supply 91, a corded power adapter connector 490 operative to be electrically connected to adapter power connector 210 of power adapter assembly 200, and any suitable supply power cord 450 of any suitable length and with any suitable number of electrically conductive conductors or conductor bundles (not shown), each of which may be operative to electrically couple a respective corded power supply connector contact of corded power supply connector 410 to a respective corded power adapter connector contact of corded power adapter connector 490. Corded power supply connector 410 may include any suitable type of connector (e.g., a 2-prong NEMA 1-15 AC plug or a 3-prong NEMA 5-15 AC plug) with any suitable number of corded power supply connector contacts, such as a first or neutral corded power supply connector contact 412a, a second or hot corded power supply connector contact 412b, and a third or grounded corded power supply connector contact 412c, for being electrically coupled to different socket connector contacts of socket connector 90 (e.g., as shown in FIGS. 1B and 1D, contact 412a may be electrically coupled to (e.g., retained within) contact 92a and contact 412b may be electrically coupled to (e.g., retained within) contact 92b and contact 412c may be electrically coupled to (e.g., retained within) contact 92c, for example, when connector 410 is mated with connector 90 in the insertion direction of arrow SI). Moreover, corded power adapter connector 490 may include any suitable type of connector (e.g., a grounded or otherwise adjusted C7 or figure 8 or shotgun connector of the IEC 60320 coupler standard) with any suitable number of corded power adapter connector contacts, such as a first or neutral corded power adapter connector contact 492a and a second or hot corded power adapter connector contact 492b and a third or grounded corded power adapter connector contact 492c, for being electrically coupled to different adapter power connector contacts of adapter power connector 210 (e.g., contact 492a may be electrically coupled to (e.g., retained about) contact 212a (e.g., within inlet 211) and contact 492b may be electrically coupled to (e.g., retained about) contact 212b (e.g., within inlet 211) and contact 492c provided within a slot 485c may be electrically coupled to (e.g., held about) contact 212c, for example, when connector 490 is mated with connector 210 in the insertion direction of arrow AI (e.g., after connector 390 is released from connector 210 in the release direction of arrow AR)). As each conductor or conductor bundle of supply power cord 450 may electrically couple a respective power supply connector contact of corded power supply connector 410 to a respective power adapter connector contact of corded power adapter connector 490 (e.g., contact 412a may be electrically coupled to contact 492a, contact 412b may be electrically coupled to contact 492b, and contact 412c may be electrically coupled to contact 492c), corded power supply connector assembly 400 may thereby be operative to electrically couple a respective socket connector contact of socket connector 90 to a respective adapter power connector contact of adapter power connector 210 (e.g., contact 92a may be electrically coupled to contact 212a, contact 92b may be electrically coupled to contact 212b, and contact 92c may be electrically coupled to contact 212c) when connector 410 is electrically coupled to connector 90 and connector 490 is simultaneously electrically coupled to connector 210 (e.g., as shown in FIG. 1D).

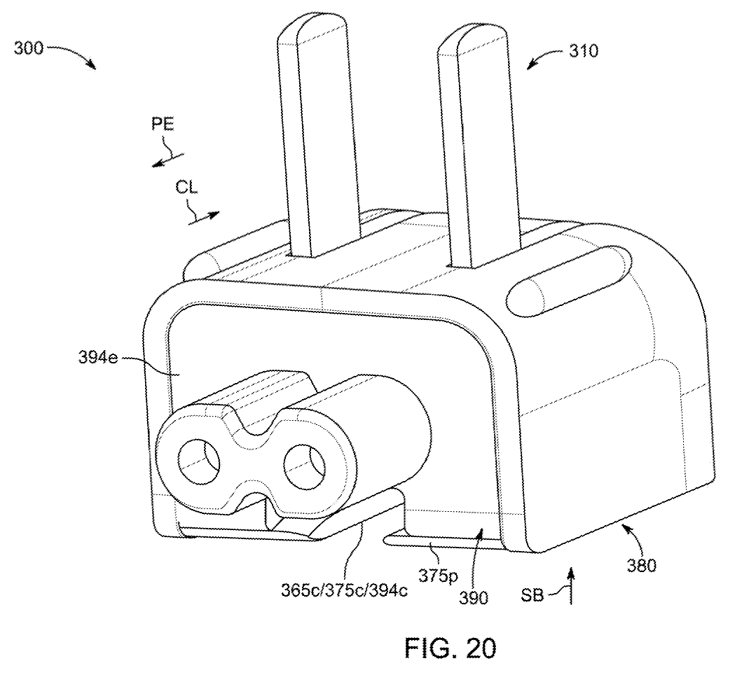

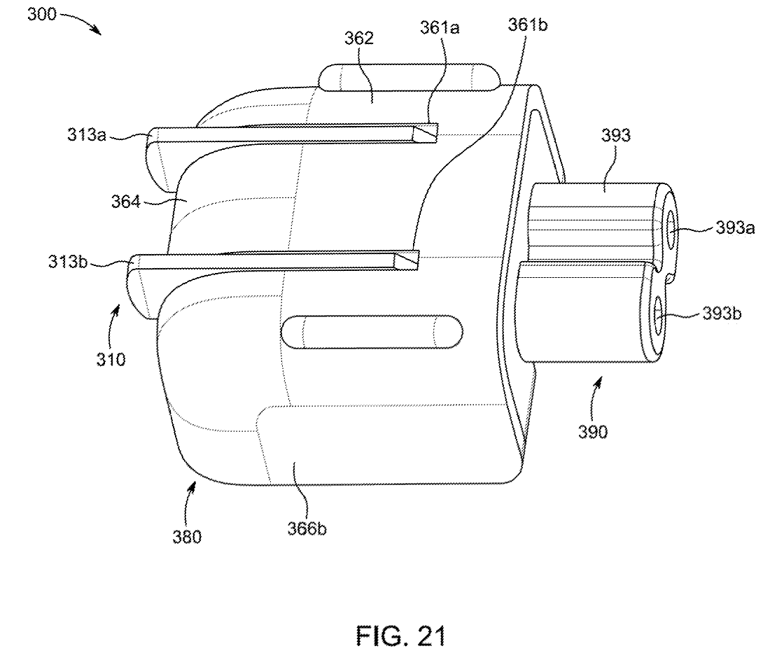

Cordless power adapter connector 390 of cordless power supply connector assembly 300 and corded power adapter connector 490 of corded power supply connector assembly 400 may be interchangeably connected to adapter power connector 210 of power adapter assembly 200 for reconfiguring how power adapter system 100 may be used to adapt power from electric power supply 91 for use by electronic device 11 (e.g., due to the difference in size and shape and length between assemblies 300 and 400). Due to the fact that an electrical connection between assemblies 200 and 300 (e.g., between the contacts of connectors 210 and 390) is not fixed but instead may be routinely terminated (e.g., by a user in the direction of arrow AR) in order to interchange assembly 300 with assembly 400 in system 100, the potential for undesirable break events between portions of system 100 may exist. Therefore, system 1 may be designed to limit the negative effects of such break events (e.g., to prevent dangerous exposure of a user to any contact of system 100 that may be electrically coupled to a socket connector contact of socket connector 90 when a break event between certain portions of system 100 may occur (e.g., when system 100 is inadvertently kicked or pulled in the direction of arrow BE and/or in the direction of arrow PE during use)). Additionally, due to the fact that an electrical connection between assemblies 200 and 300 is not fixed, the likelihood of an undesirable gap between the housings of the assemblies may be increased (e.g., gap G of FIG. 1A between assembly 200 and assembly 300). Therefore, system 1 may be designed to limit such a gap (e.g., to prevent a cosmetic distraction and/or to prevent debris from accessing and negatively affecting electrical connections within system 100). Additionally, due to the fact that an electrical connection between assemblies 200 and 300 is not fixed, the desire to store assembly 300 when not in use may be increased. Therefore, system 1 may be designed to enable reduction in the size of assembly 300 when not in use (e.g., by enabling a simple user experience for rotating the contacts of connector 310 from a functional or open position extending out from housing 301 (e.g., the open position of FIGS. 1A-1C and 20 for coupling the contacts to socket connector 90 of electric power supply 91) to a non-functional or closed position extending within housing 301 (e.g., the closed position of FIG. 21 for compactly storing assembly 300)).

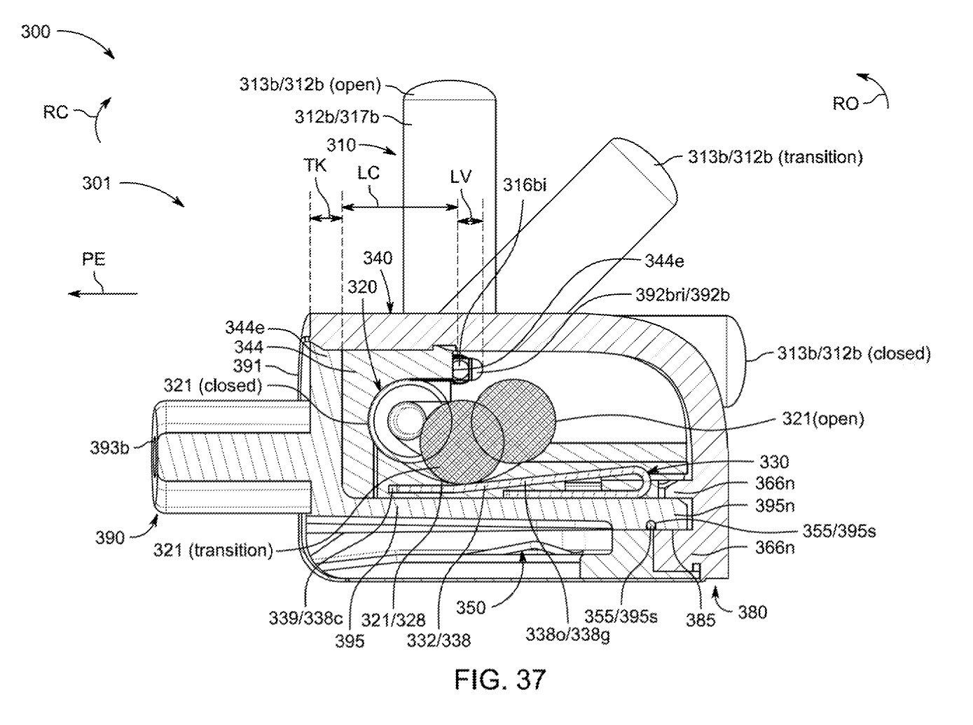

As shown in FIGS. 3-48, cordless power connector housing 301 of power supply connector assembly 300 may not only be operative to protect at least a portion of each power supply connector contact of power supply connector 310 and at least a portion of each power adapter connector contact of power adapter connector 390, but also housing 301 may protect an electrical coupling between each power supply connector contact and a respective power adapter connector contact (e.g., housing 301 may protect a first electrical coupling between contact 312a and contact 392a as well as a second electrical coupling between contact 312b and contact 392b (see, e.g., FIG. 37)). Moreover, housing 301 may be operative to protect any live contacts (e.g., any contacts of assembly 300 electrically coupled to electric power supply 11) from being accessible to a user when connector assembly 300 endures one or more types of break event, such as a first break event that may pull connector 390 away from connector 310 in the direction of arrow PE and/or a second break event that may pull contact 212c of assembly 200 away from assembly 300 in the direction of arrow AO (e.g., due to a kick event on system 100 in the direction of arrow BE when connector 310 is electrically coupled to socket connector 90). As shown, assembly 300 may include, in addition to connector 310 and connector 390, a prong bridge 320, a prong spring 330, a protection body 340, a gap spring 350, and an outer shell 380 that may include a first outer shell structure 360 and a second outer shell structure 370. Various portions of one or more of connector 310, connector 390, bridge 320, spring 330, body 340, spring 350, and shell 380 may form housing 301 for protecting the contacts of connector 310 and the contacts of connector 390.

Outer case or shell 380 may be provided as at least a portion of housing 301 for protecting one or more contacts of assembly 300. As shown, outer shell 380 may include a top wall structure 362, a front wall structure 364, a first (e.g., left) side wall structure 366a, a second (e.g., right) side wall structure 366b, and a bottom wall structure 385, which together may form a five-sided box structure defining an interior shell volume or space 369 (e.g., a five-sided box may be used herein to refer to any suitable three-dimensional structure, such as with an open end, that may define any suitable interior space or volume (e.g., on at least five sides), where at least a portion or the entirety of an edge between any two adjacent sides may be curved or straight, and/or where at least a portion or the entirety of a corner between any three adjacent sides may be curved or pointed, and/or any surface of any side may be substantially planar or at least partially curved or any other suitable shape therealong). Outer shell 380 may be made from any suitable material, such as polycarbonate resin (e.g., Emerge™ PC 8600-10), or combination of materials that may be able to insulate and protect the contents to be positioned within interior shell space 369. Outer shell 380 may be operative to provide a cosmetic exterior for a significant portion of assembly 300, while a contact slot 385c, which may be provided through bottom wall 385, as well as a rear opening 367 (e.g., absence of a rear wall for forming a six-sided box) may provide access to interior shell space 369. Interior space 369 may be a volume of space that may be defined between walls 362, 364, 385, 366a, and 366b, as well as a missing surface (e.g., an open end of the five-sided box) that may extend between the adjacent edges of walls 362, 385, 366a, and 366b (e.g., opposite wall 364) and that may define rear opening 367 (e.g., a cuboid shaped space). Although the general shape of outer shell 380 may be substantially similar to the exterior of a rectangular cuboid with at least some rounded edges and/or corners and only five faces, it is to be understood that outer shell 380 may be configured to provide any other suitably shaped exterior structure for defining interior shell space 369 and a portion of housing 301, such as any suitable portion of any suitable polyhedron, polytope, sphere, or any other suitable three-dimensional geometrical object that may be provided with an open end or other suitable opening (e.g., opening 367 (e.g., for receiving additional portions of assembly 300)) through which the interior shell space may be accessed.

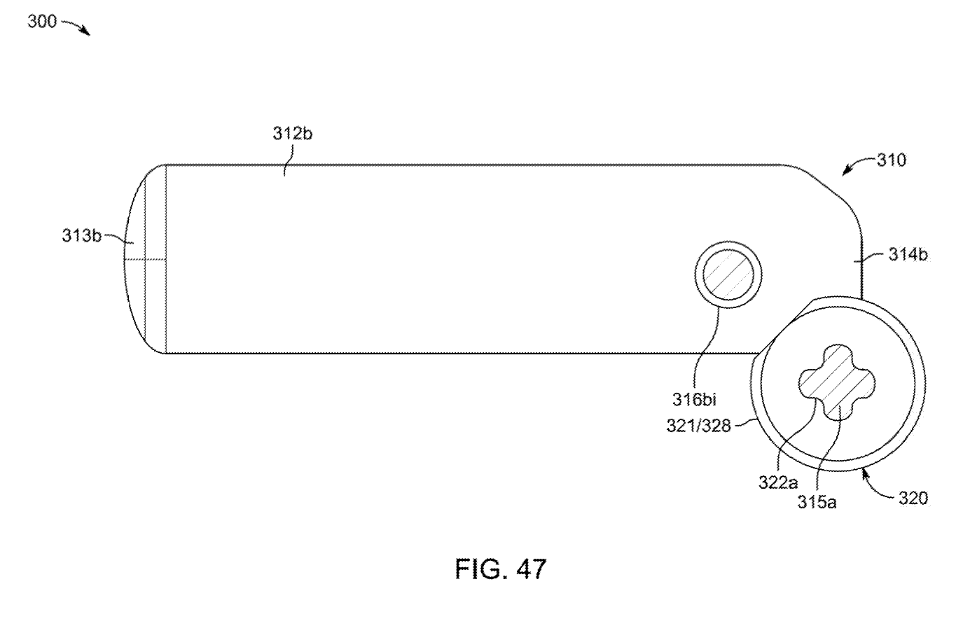

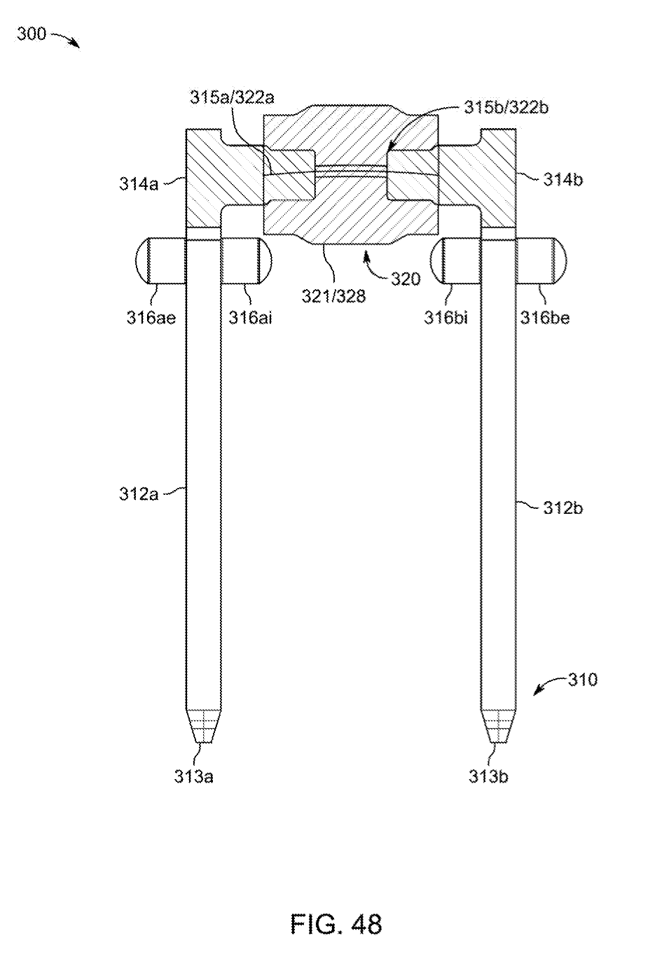

Connector 310 may include one or more power supply connector contacts, such as contact 312a and contact 312b, each of which may be at least partially positioned within interior shell space 369. For example, as shown, a main body 317a of first contact 312a may extend between a contact tip 313a and a contact base 314a, while a main body 317b of second contact 312b may extend between a contact tip 313b and a contact base 314b. Prong bridge 320 may be provided to physically couple yet electrically insulate contacts 312a and 312b. For example, as shown, contact 312a may include a contact bridge extension 315a that may extend away from main body 317a of contact 312a (e.g., at or near contact base 314a), contact 312b may include a contact bridge extension 315b that may extend away from main body 317b of contact 312b (e.g., at or near contact base 314b). A portion of each contact bridge extension may be physically coupled to a respective portion of prong bridge 320. As just one example, as shown in FIGS. 47 and 48, a main body 321 of bridge 320 may include a first contact recess 322a on a first side of body 321 for receiving and holding a free end of contact bridge extension 315a therein and a second contact recess 322b on a second side of body 321 for receiving and holding a free end of contact bridge extension 315b therein. Glue or any other suitable adhesion technique may be used to fix contact bridge extensions 315a and 315b within respective contact recesses 322a and 322b. Additionally or alternatively, a cross-sectional shape of an extension and its respective recess may be shaped to prevent rotation of the extension within the recess (e.g., as shown by the cross-shaped shape of extension 315a and recess 322a in FIG. 47). Therefore, contacts 312a and 312b may be held in a fixed relationship with respect to one another by bridge 320. Body 321 of bridge 320 may be made of any suitable material or combination of materials that may be rigid enough to maintain a physical coupling to each one of contacts 312a and 312b and to maintain the fixed physical relationship between contacts 312a and 312b, but that may be an insulator for preventing electric current to flow between contacts 312a and 312b via bridge 320, including, but not limited to, any suitable ceramic, such as zirconium dioxide, or rubber or plastic or the like. Each one of contacts 312a and 312b may be made of any suitable material or combinations of material that may conduct electricity (e.g., to conduct electricity from respective contacts of electric power supply 91), including, but not limited to, brass, bronze, and/or the like.

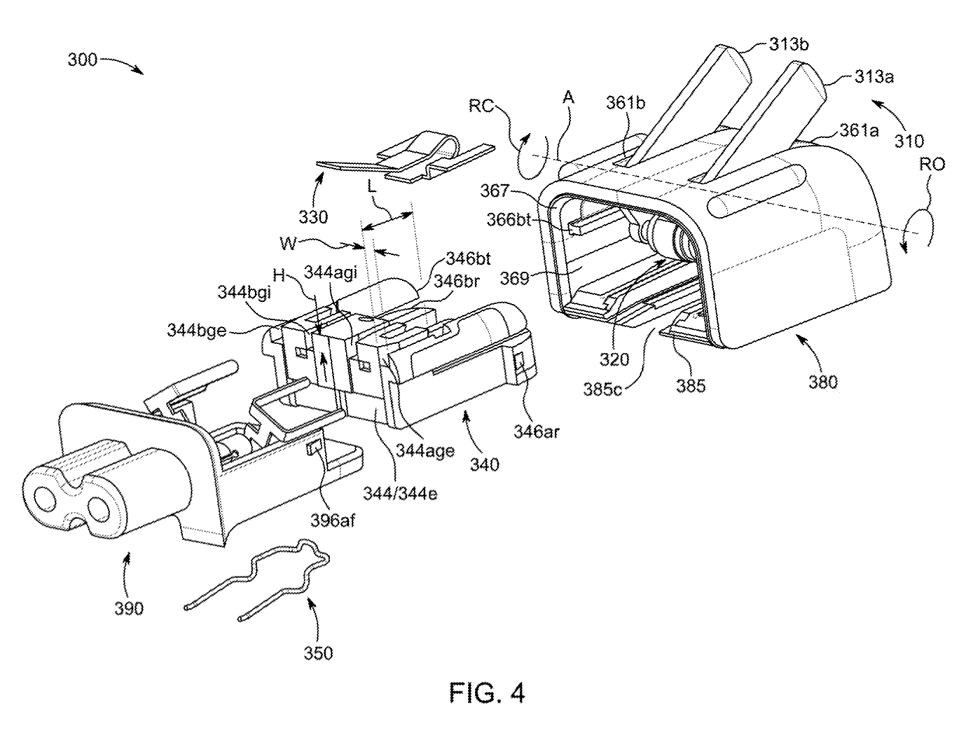

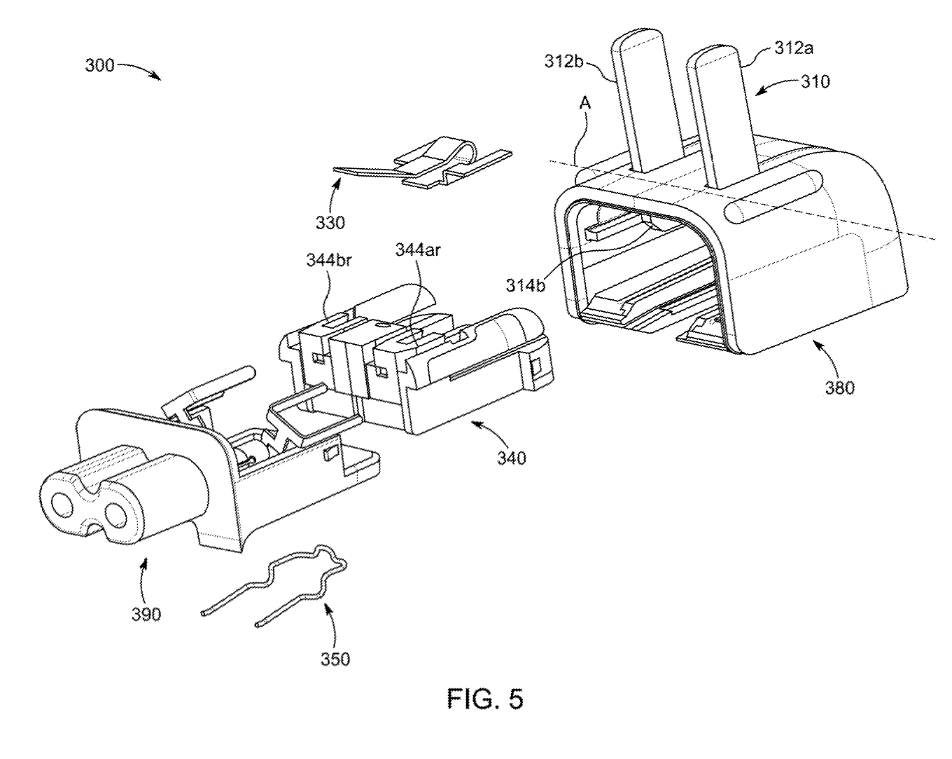

Each contact of connector 300 may also include one or more features for helping to define an axis of rotation A for that contact with respect to outer shell 380. For example, contact 312a may include an interior contact axis extension 316ai and an exterior contact axis extension 316ae, which may extend away from main body 317a of contact 312a in opposite directions (e.g., just above bridge extension 315a), while contact 312b may include an interior contact axis extension 316bi and an exterior contact axis extension 316be, which may extend away from main body 317b of contact 312b in opposite directions (e.g., just above bridge extension 315b). Moreover, outer shell 380 may include one or more mechanical features for helping to define an axis of rotation A for each contact of connector 300. For example, as shown, outer shell 380 may define features 366ae, 366ai, 366bi, and 366be for interacting with respective ones of contact axis extensions 316ae, 316ai, 316bi, and 316be for at least partially defining an axis of rotation A for respective contacts 312a and 312b of connector 310 with respect to outer shell 380. Outer shell 380 may also include a connector slot for enabling a portion of a respective contact of connector 300 to pass through outer shell 380 (e.g., in order to be exposed to contacts of socket connector 90 of electric power supply 91. For example, as shown, outer shell 380 may include a first connector slot 361a (e.g., through a first portion of top wall 362 and/or front wall 364) for enabling a portion of first connector 312a (e.g., at least contact tip 313a) to pass therethrough and a second connector slot 361b (e.g., through a second portion of top wall 362 and/or front wall 364) for enabling a portion of second connector 312b (e.g., at least contact tip 313b) to pass therethrough. For example, as shown between the different stages of configuration of FIGS. 3-5, once contacts 312a and 312b of connector 310 have been coupled to bridge 320, bridge 320 and connector 310 may together be inserted into interior space 369 of outer shell 380 via rear opening 367, such that at least contact tip 313a of contact 312a may extend through connector slot 361a and out from interior space 369 and such that at least contact tip 313b of contact 312b may extend through connector slot 361b and out from interior space 369, and then respective ones of contact axis extensions 316ae, 316ai, 316bi, and 316be of connector 310 may be aligned with and interact with features 366ae, 366ai, 366bi, and 366be of outer shell 380 for defining axis A and for enabling rotation of contacts 312a and 312b about axis A from the transition position of FIG. 4 to the open position of FIG. 5. Connector slots 361a and 361b may be shaped to prevent the entirety of respect contacts 312a and 312b to pass therethrough (e.g., one or both of contact axis extensions 316ai and 316ae may prevent the entirety of contact 312a (e.g., absent prong bridge 320) to pass out from interior space 369 via connector slot 361a and/or one or both of contact axis extensions 316bi and 316be may prevent the entirety of contact 312b (e.g., absent prong bridge 320) to pass out from interior space 369 via connector slot 361b).

Protection body 340 may be positioned within interior space 369 for protecting one or more portions of connector 310 within interior space 369 from accessibility by a user of assembly 300, while also enabling contacts of connector 390 to access and be electrically coupled to connector 310. For example, as shown, protection body 340 may include a cap or rear wall structure 344, a bottom wall structure 345 with a top or interior surface 345i and a bottom or exterior surface 345e, a first side wall structure 346a, and a second side wall structure 346b, which together may form the overall structure of protection body 340. Although a particular shape of protection body 340 may be shown, it is to be understood that protection body 340 may be any suitable shape that may be operative to protect contacts of connector 310 within interior space 369 of outer shell 380. Protection body 340 may be made from any suitable material, such as polycarbonate resin (e.g., Emerge™ PC 8600-10), or combination of materials that may be able to insulate and protect certain contents to be positioned within interior shell space 369. In some embodiments, at least a portion or the entirety of protection body 340 may be provided as a portion of outer shell 380 (e.g., formed as a portion of structure 380 (e.g., formed as a portion of structure 360 and/or as a portion of structure 370)).

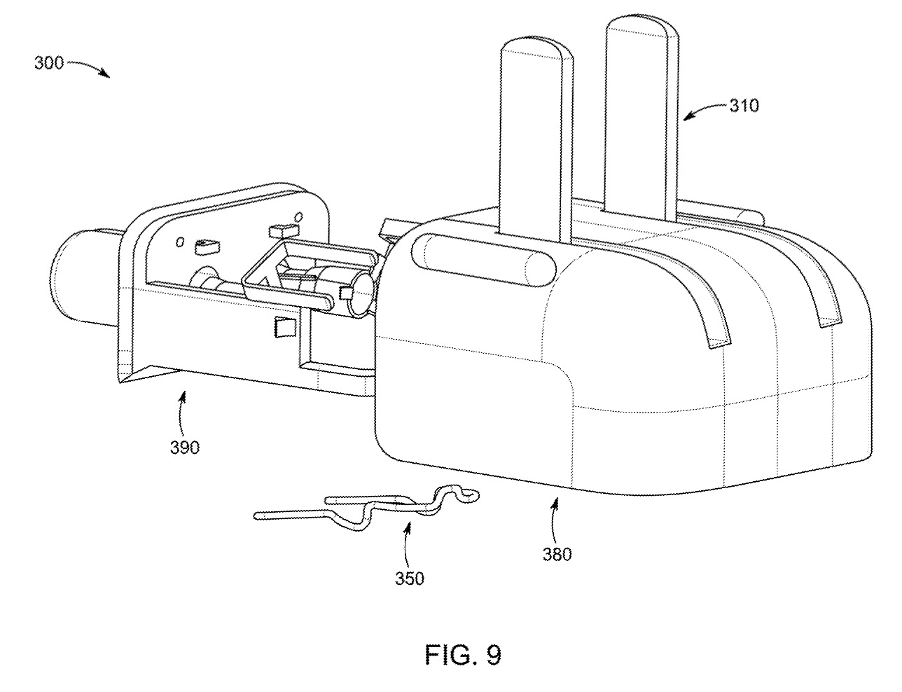

Protection body 340 may also be used to help define an axis of rotation A for one or more contacts of connector 300. For example, as shown, protection body 340 (e.g., a top of rear wall structure 344) may define features 344ae, 344ai, 344bi, and 344be for interacting with respective ones of contact axis extensions 316ae, 316ai, 316bi, and 316be for at least partially defining an axis of rotation A for respective contacts 312a and 312b of connector 310 with respect to outer shell 380. Each one of features 344ae, 344ai, 344bi, and 344be may be provided at an interior surface 344i of rear wall structure 344, such that each one of features 344ae, 344ai, 344bi, and 344be may be operative to face and interact with a respective one of contact axis extensions 316ae, 316ai, 316bi, and 316be within interior space 369. For example, when protection body 340 may be inserted into and retained within at least a portion of interior space 369 (e.g., as shown in the transition from the configuration of FIG. 8 to the configuration of FIG. 9 of assembly 300), feature 344ae may together with feature 366ae limit the movement of contact axis extension 316ae to rotation about axis A, feature 344ai may together with feature 366ai limit the movement of contact axis extension 316ai to rotation about axis A, feature 344bi may together with feature 366bi limit the movement of contact axis extension 316bi to rotation about axis A, and feature 344be may together with feature 366be limit the movement of contact axis extension 316be to rotation about axis A. Additionally or alternatively, as shown, protection body 340 (e.g., a top of rear wall structure 344) may define features 344ar and 344br for allowing movement of a portion of respective contacts 312a and 312b to rotate therethrough when protection body 340 may be retained within interior space 369 of outer shell 380.

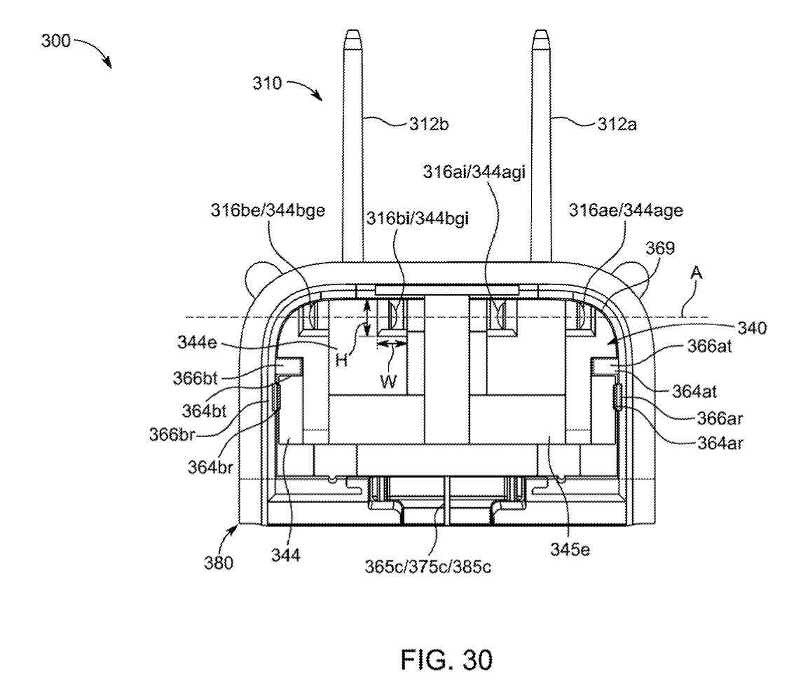

Additionally, as shown, protection body 340 (e.g., a top of rear wall structure 344) may at least partially define (e.g., alone or in conjunction with one or more surfaces of shell 380 (e.g., an interior surface of wall 362)) one or more recess guides 344age, 344agi, 344bgi, and 344bge extending through and/or along a portion of body 340 for enabling a respective contact portion of one or more contacts of connector 390 to pass therethrough for accessing a respective contact portion of one or more contacts of connector 310 for electrically coupling contacts of connector 390 to contacts of connector 310. Each one of recess guides 344age, 344agi, 344bgi, and 344bge may extend from a first end at a respective portion of an exterior surface 344e of rear wall structure 344 towards a second end at a respective portion of interior surface 344i of rear wall structure 344, where each second end of a respective one of recess guides 344age, 344agi, 344bgi, and 344bge may be adjacent and/or otherwise proximate to a respective one of axis features 344ae, 344ai, 344bi, and 344be. As shown in FIGS. 18 and 30, for example, when protection body 340 has been positioned within interior space 369 of outer shell 380, but prior to passage of a portion of the contacts of connector 390 through recess guides 344age, 344agi, 344bgi, and 344bge for electrical coupling to the contacts of connector 390, the portions of contacts 312a and 312h of connector 390 positioned within interior spacing 369 of outer shell 380 may not be accessible to human touch by a user of assembly 300. For example, the dimensions of recess guides 344age, 344agi, 344bgi, and 344bge (e.g., at any suitable position along the guide) may be configured such that a human finger may be too large to access a portion of contact 312a and/or 312b within interior space 369 via recess guides 344age, 344agi, 344bgi, and 344bge. For example, each one of a height H and a width W of a recess guide (e.g., at any suitable position along the guide) may be less than 4 millimeters and, in some embodiments, less than 3 millimeters, or otherwise shaped to prevent a human from inserting a finger therein or therethrough for contacting a portion of contact 312a and/or of contact 312b within interior space 369 via protection body 340. Length L of one or more recess guides 344age, 344agi, 344bgi, and 344bge may be any suitable length, such as 8 millimeters or 7 millimeters or any other suitable length. Therefore, although a portion of contact 312a and a portion of contact 312b within interior space 369 may be positioned between portions of side wall structures 346a and 346b of protection body 340 adjacent an interior surface of top wall 362 of shell 380 and adjacent, but, possibly, a distance from an interior surface of rear wall structure 344, when protection body 340 is retained within interior space 369 of outer shell 380, protection body 340 may be operative to prevent a user from directly accessing (e.g., directly contacting or touching) the portions of contacts 312a and 312b within interior space 369 (e.g., portions of contacts 312a and 312b that may be hot or live when connector 310 is electrically coupled to socket connector 390 (e.g., when contact tip 313a of contact 312a is electrically coupled to socket connector contact 92a and when contact tip 313b of contact 312b is electrically coupled to socket connector contact 92b)). As a particular example, as shown in FIG. 30, contact axis extension 316bi of contact 312b of connector 310 may be accessible by a contact of connector 390 (e.g., contact arm 392bri of contact 392b of connector 392) via recess guide 344bgi, which may have an initial first end opening through exterior surface 344e of rear wall structure 344 with cross-sectional area of W by H, and, yet, contact axis extension 316bi of contact 312b of connector 310 may be removed from such an initial first end opening through exterior surface 344e of rear wall structure 344 by a length LC (e.g., any suitable length, such as 7 millimeters or 8 millimeters or 9 millimeters or any other suitable length), as shown in FIG. 37. Therefore, even if a user might have access to exterior surface 344e of rear wall structure 344 when protection body 340 is assembled within interior space 369, a user may not be able to physically contact any portion of contact axis extension 316bi of contact 312b of connector 310 via recess guide 344bgi due to the limited cross-sectional area and/or extended length of recess guide 344bgi. Moreover, as shown in FIG. 30, for example, no other portion of connector 310 (e.g., no other portion of contact 312a and/or contact 312b) within interior space 369, other than contact axis extensions 316be, 316bi, 316ai, and 316ae, may even be visible to a user (e.g., due to one or more protective surfaces of protection body 340). Therefore, protection body 340 may be operative to protect connector 310 from being accessible within interior space 369 of shell 380 by a user.

Protection body 340 may include one or more features operative to interact with one or more respective features of outer shell 380 for properly retaining protection body 340 within interior space 369 of outer shell 380. For example, body 340 may include any suitable top interaction feature 344u (e.g., a ramp or nub feature on a top surface of wall structure 344 of body 340) that may be operative to interact with (e.g., snap into) an interaction feature 366u (e.g., a recess within an interior surface of top wall 362 of shell 380) when body 340 is inserted into space 369 of shell 380. Additionally or alternatively, body 340 may include any suitable side interaction snap features 346ar and 346br (e.g., a ramp or nub feature on an exterior surface of each one of first and second wall surfaces 346a and 346b of body 340) that may be operative to interact with (e.g., snap into) a respective one of interaction features 366ar and 366br (e.g., a recess within an interior surface of first side wall 366a and a recess within an interior surface of second side wall 366b) when body 340 is inserted into space 369 of shell 380. Additionally or alternatively, body 340 may include any suitable side interaction slide features 346at and 346bt (e.g., a slot or other feature at least partially through the exterior surface of each one of first and second wall surfaces 346a and 346b of body 340) that may be operative to interact with (e.g., slide along) a respective one of interaction features 366at and 366bt (e.g., a support feature extending from an interior surface of first side wall 366a and a support feature extending from an interior surface of second side wall 366b) when body 340 is inserted into space 369 of shell 380. Any suitable number and/or types of respective interaction features may be provided by any suitable portions of body 340 and shell 380 at any suitable locations for interacting with each other within interior space 369 for at least partially retaining body 340 at an appropriate location within space 369. Additionally or alternatively, any suitable adhesion technique (e.g., glue) may be used to hold body 340 in its functional position within interior space 369.

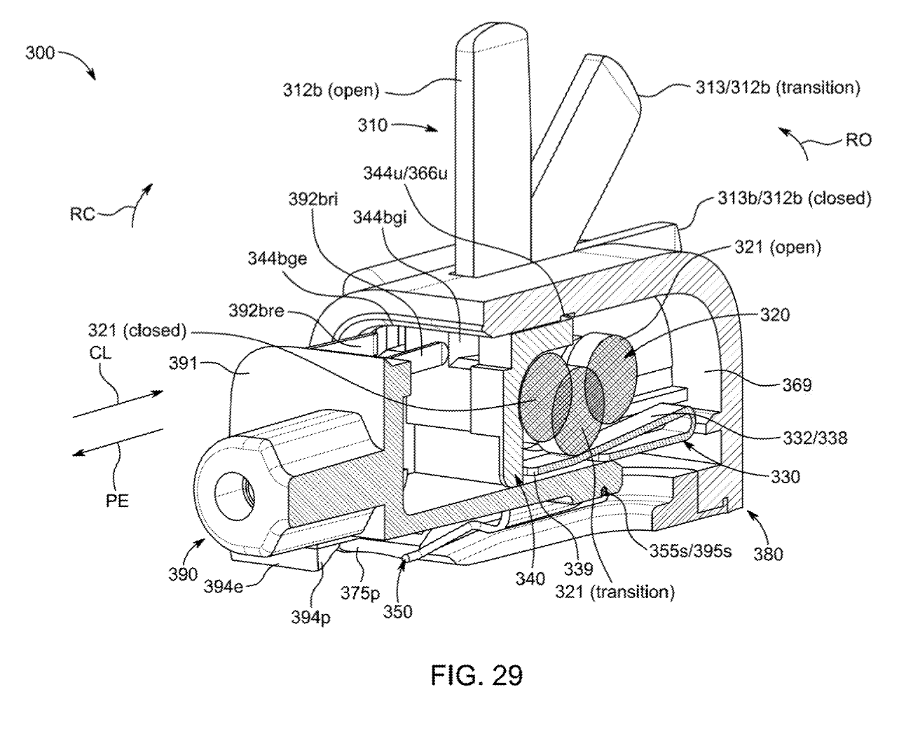

As shown in FIG. 8, for example, prior to inserting body 340 into interior space 369 for retention therein, prong spring 330 may be coupled to body 340 such that spring 330 may also be retained within interior space 369. Spring 330 may be any suitable spring or combination of two or more springs that may be operative to bias bridge 320 and, thus, connector 310 into one of two stable positions with respect to shell 380 (e.g., the open position of FIG. 20 or the closed position of FIG. 21). As just one example, as shown, spring 330 may include at least a first spring body 332 extending between a fixed end 331 and a free end 339 via a curved portion 337. Spring body 332 may be provided by any suitable material or combination of materials, including, but not limited to, stainless steel (e.g., spring steel). Spring body 332 may also include one or more wings 335a and 335b extending from fixed end 331, where each wing may be operative to interact with a wing support feature of protection body 340 to fix fixed end 331 with respect to protection body 340 and, thus with respect to shell 380 in the final configuration of assembly 300. For example, as shown, protection body may include a first wing support feature 345a and a second wing support feature 345b (e.g., slots provided by bottom wall structure 345 or otherwise), and wing 335a may be operative to slide into and be held by wing support feature 345a while wing 335b may be operative to slide into and be held by wing support feature 345b, thus holding, fixed end 331 of spring body 332 with respect to protection body 340. When protection body 340 is then inserted into and retained within interior space 369 of shell 380, a bridge surface 338 of spring body 332 extending between free end 339 and curve 337 may be operative to interact with (e.g., support) a spring surface 328 of main body 321 of prong bridge 320 (see, e.g., FIGS. 29, 36, and 37). Such an interaction may be operative to bias bridge 320 and, thus, connector 310 into one of two stable positions with respect to shell 380 (e.g., the open position of FIG. 20 or the closed position of FIG. 21). Curved portion 337 may be operative to define angles θ1, θ2, and θ3 with respect to fixed end 331 and a first ray of curved portion 337, the two rays of curved portion 337, and the second ray of curved portion 337 and an initial extension portion 337i, respectively, while initial extension portion 337i may be operative to define angle 84 with respect to bridge surface 338.

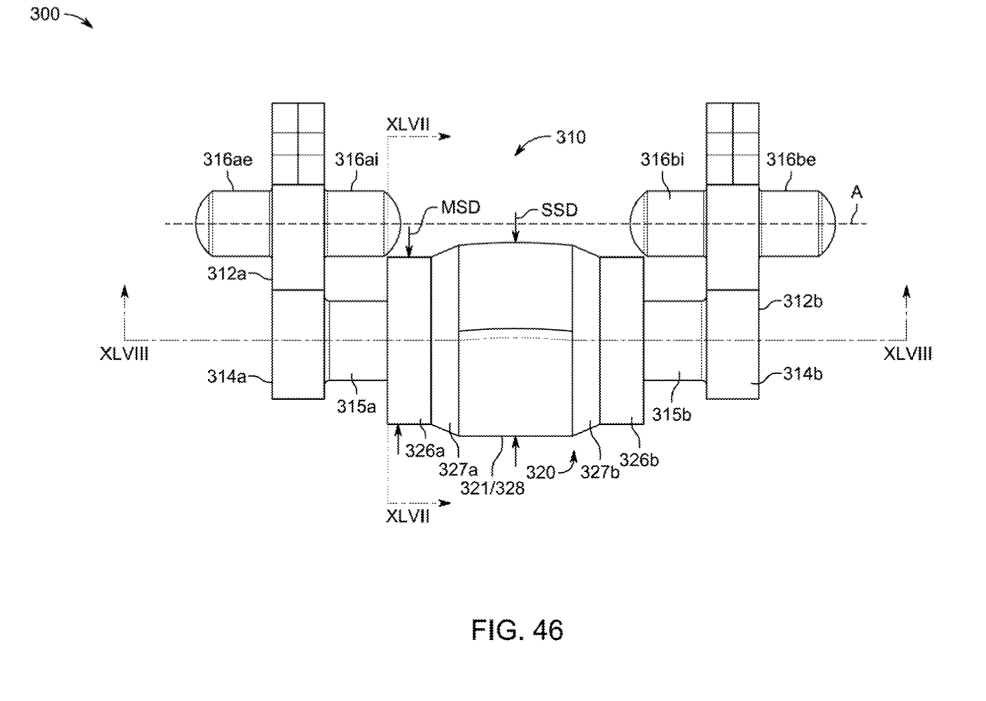

As shown, an exterior surface of main body 321 of prong bridge 320 may include a first mate surface 326a about at least a portion of prong bridge 320 that includes contact recess 322a, a first flare surface 327a extending from first mate surface 326a to spring surface 328, a second mate surface 326b about at least a portion of prong bridge 320 that includes contact recess 322b, and a second flare surface 327b extending from second mate surface 326b to spring surface 328. Each one of first mate surface 326a and second mate surface 326b may be defined by a first cross-sectional dimension (e.g., diameter) MSD, while spring surface 328 may be defined by a second cross-sectional dimension (e.g. diameter) SSD that may be larger than dimension MSD, and while each one of first flare surface 327a and second flare surface 327b may have a cross-sectional dimension (e.g., diameter) that varies along the flare surface from dimension MSD to dimension SSD (e.g., as shown in FIG. 46). Moreover, although the exterior surface of spring surface 328 may generally be a right circular cylinder with a diameter SSD, one or more particular portions, such as flat portion 329 may not be of a cylindrical shape, where flat portion 329 and/or any other surface portion of spring surface 328 may be designed to most efficiently interact with the size and shape of interior space 369 within which spring surface 328 may be positioned and move during use. Additionally or alternatively, flat portion 329 may be used as a visual guide for the orientation of bridge 320.

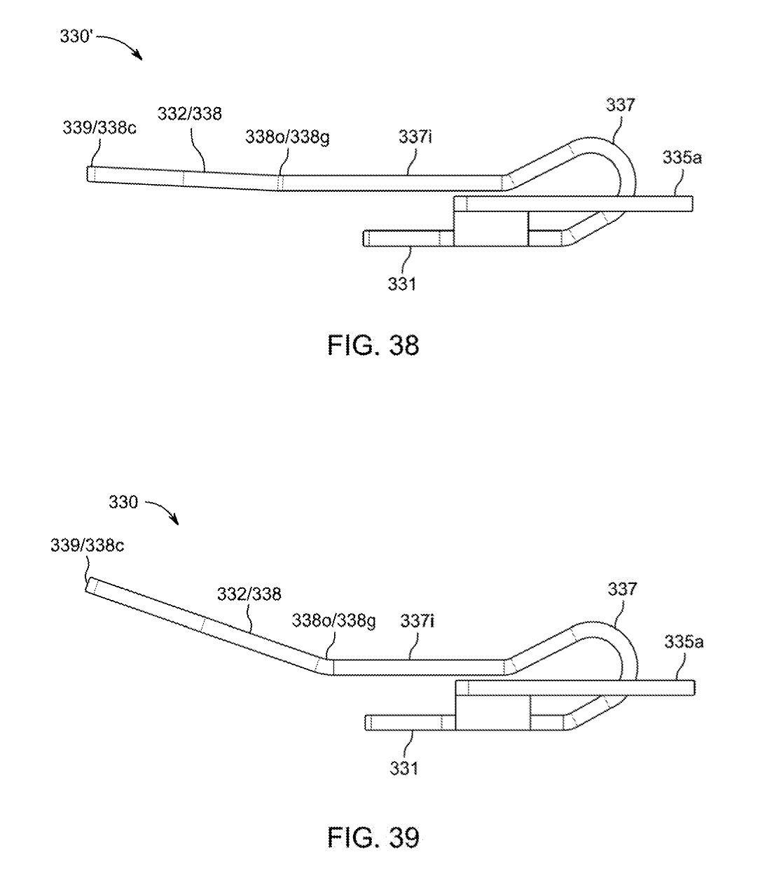

Once assembly 300 is assembled, bridge surface 338 of spring body 332 of prong spring 330 may interface with (e.g., contact) a portion of spring surface 328 of prong bridge body 321 of prong bridge 320 regardless of whether contacts 312a and 312b have been rotated about axis A (e.g., in the direction of arrow RO) to the open position of contacts 312a and 312b and prong bridge body 321 (e.g., as shown in FIGS. 1A-1C, 5-20, 29, 30, 36, and 37) or whether contacts 312a and 312b have been rotated about axis A (e.g., in the direction of arrow RC) to the closed position of contacts 312a and 312b and prong bridge body 321 (e.g., as shown in FIGS. 21, 29,36, and 37), where such an interface may be free from as many disturbances as possible (e.g., by providing each one of surfaces 338 and 328 to be as smooth as possible and/or to provide grease or some other appropriate agent therebetween to facilitate disturbance free motion of prong bridge body 321 with respect to spring bridge surface 338). One or more spring characteristics of spring 330 and the position of prong bridge body 321 with respect to spring 330 throughout the movement of prong bridge body 321 during rotation of the connector contacts between the open and closed positions when assembly 300 has been fully assembled may be configured such that the subassembly of connector contacts 312 and prong bridge 320 may only be stable in each one of the open and closed positions of the connector contacts but not in any one of the transition positions therebetween. For example, as shown, the closed position of prong bridge body 321 (e.g., when the connector contacts are in the closed position) may provide prong bridge body 321 at or proximate to free end 339 of prong spring 330 (e.g., at a position 338c) when spring 330 is in or close to its relaxed state (e.g., a state when no external force may be applied to spring 330 between curve 337 and free end 339 (e.g., as shown in FIG. 39 (e.g., for a spring 330 that may be bent (e.g., with an angle of 15°)) or as shown in FIG. 38 (e.g., for a similar spring 330′ but one that may be pre-bent (e.g., with an angle of 4°)))), which may not result in much, if any, force being applied by prong bridge body 321 on prong spring 330 counter to any force that spring 330 may be applying to prong bridge body 321. The angle at which the spring may be bent may alter a force required to close the spring (e.g., increasing the angle from 4° to 15° may increase the force required to close the spring), but may not do much to change the amount of force that may be required to open the spring. Therefore, such an angle may be a tuning mechanism to get a desired prong rotation torque. The various angles may be tuned in any suitable manner, such as in a way to avoid material yielding, and/or to avoid a collision of the spring against itself during the rotation of the prong assembly. One or more of the angles may also change a length of a moment arm, and, thus, the moment that may be applied. Moreover, as shown, the open position of prong bridge body 321 (e.g., when the connector contacts are in the open position) may provide prong bridge body 321 at or proximate to a location 338o of prong spring 330 when spring 330 is in or close to its relaxed state (e.g., a location that may be at or close to a location 338g that may initiate a flat portion of surface 338 extending towards curve 337 (e.g., parallel to fixed end portion 331), which may include a groove to help align location 338o at location 338g (e.g., as shown in FIG. 38 or FIG. 39)), which may not result in much, if any, force being applied by prong bridge body 321 on prong spring 330 counter to any force that spring 330 may be applying to prong bridge body 321. However, as shown, any transition position of prong bridge body 321 (e.g., when the connector contacts are in between the open position and the closed position) may provide prong bridge body 321 at a transition location along bridge surface 338 of prong spring 330 between position 338c and position 338o, which may result in some force being applied by prong bridge body 321 on prong spring 330 counter to a force that spring 330 may be applying to prong bridge body 321 in an attempt to return to its relaxed state. This may result in the connector contacts and prong bridge body 321 being stable in only the closed and open positions, and, instead, while at any transition position, spring 330 may be deformed from its relaxed state and configured to exert a force on bridge body 321 for returning the connector contacts and prong bridge body 321 to one of the stable open and closed positions.

These characteristics of spring 330 and this relative movement of prong bridge body 321 within interior space 369 may be configured to enable a smooth transition between the closed and open positions, without any other stable position therebetween, which improves the user experience and prevents assembly 300 from remaining in an undesired position (e.g., halfway in between open and closed while assembly 300 is not coupled to assembly 200 but is intended to be stored for later use). Additionally or alternatively, such characteristics of spring 330 and such relative movement of prong bridge body 321 within interior space 369 may be configured to enable the open position to be more stable than the closed position, whereby the spring force that may be exerted by spring 330 on prong bridge body 321 as prong bridge body 321 attempts to move initially from the open position 338o along surface 338 of spring 330 towards the closed position 338c along surface 338 of spring 330 may be larger than the spring force that may be exerted by spring 330 on prong bridge body 321 as prong bridge body 321 attempts to move initially from the closed position 338c along surface 338 of spring 330 towards the open position 338o along surface 338 of spring 330. This may enable connector 310 to require more force (e.g., from a user) to move connector contacts 312a and 312b from their open position to their closed position than to move connector contacts 312a and 312b from their closed position to their open position, which may more easily allow for a transition position to be used during initial insertion of contact tips 313a and 313b into respective contacts 92a and 92b of socket connector 90 of electric power supply 91. Although a single spring body 332 of prong spring 330 and a single spring surface 328 of a single main body 321 of a prong bridge 320 may be shown for use with the rotation of each one of connector contacts 312a and 312b, it is to be understood that, in other embodiments, the rotation of each one of connector contacts 312a and 312b may involve its own respective prong spring body and/or its own respective prong bridge body in a similar manner. Various characteristics of one or more of prong bridge 320, spring 330, and connector 310 may be varied or otherwise defined to provide desired action (e.g., prong stability between open and closed positions). For example, the moment (e.g., torque) may change with moment aim length, a longer moment arm may provide a larger moment, and/or congruently a bottom spring force may change depending on where prong bridge 320 may contact spring 330. Additionally or alternatively, for example, the lower and/or closer bridge 320 may get to the base of spring 330, the higher the force may be that may be applied to bridge 320. Additionally or alternatively, for example, in the open position and/or the closed position, the moment arm may be the longest or substantially the longest, whereas in the middle of the prong rotation, the moment arm may be the lowest or substantially the lowest (e.g., close to 0). Additionally or alternatively, for example, stability (e.g., in the open position) may be at least partially determined by the position of interior contact axis extension 316ai and/or exterior contact axis extension 316ae and/or interior contact axis extension 316bi and an exterior contact axis extension 316be relative to the center of the prong. Additionally or alternatively, for example, the force is most likely to be exerted along the center of the prong during insertion to a wall outlet. For example, with respect to FIG. 45, the farther to the right that exterior contact axis extension 316ae may be positioned, the more stable it may act, as the force to insert the prong it into the outlet may create a torque to keep the prong in the open position.

Connector 390 may be equipped with an adapter connector body 391 of any suitable shape that may be operative to support connector contacts 392a and 392b, that may be coupled to shell 380 and/or protection body 340 for defining assembly 300, and that may be mated with assembly 200 (e.g., with inlet 211) for facilitating a robust electrical connection between connectors 392a and 392b and respective connector contacts 212a and 212b. For example, as shown, adapter connector body 391 may include a cap or rear wall structure 394 with an interior cap surface 394i and an exterior cap surface 394e, an adapter mating structure 393 extending away from exterior cap surface 394e, a bottom wall structure 345 with an interior bottom surface 395i and an exterior bottom surface 395e, a first side wall structure 396a, and a second side wall structure 396b, which together may form the overall structure of adapter connector body 391. Although a particular shape of connector body 391 of connector 390 may be shown, it is to be understood that connector body 391 may be any suitable shape that may be operative to protect and support contacts 392a and 392, couple to shell 380 and/or protection body 340, and mate with connector 210 of assembly 200. Adapter connector body 391 may be made from any suitable material, such as polycarbonate resin (e.g., Emerge™ PC 8600-10), or combination of materials that may be able to insulate and protect certain contents to be positioned therein and/or thereagainst.

Adapter mating structure 393 may be any suitable shape that may be operative to at least partially protect at least a portion of contacts 392a and 392b and interface or mate in any suitable way with connector 210 of assembly 200 for facilitating the electrical coupling between contacts 392a and 392b and respective contacts 212a and 212b of connector 210. For example, as shown, adapter mating structure 393 may be shaped such that it may be received by inlet connector mating structure 211 of assembly 200 (e.g., adapter mating structure 393 may be operative to provide a C7 or figure 8 or shotgun connector of the IEC 60320 coupler standard while inlet connector mating structure 211 may be operative to provide a C8B inlet type of the IEC 60320 coupler standard). Adapter mating structure 393 may include one or more contact passageways, such as a first contact passageway 393a extending through structure 393 and a remainder of adapter connector body 391 (e.g., through rear wall structure 394) and a distinct second contact passageway 393b extending through structure 393 and a remainder of adapter connector body 391 (e.g., through rear wall structure 394). First contact passageway 393a may be operative to receive and hold at least a portion of first connector contact 392a therein, while second contact passageway 393b may be operative to receive and hold at least a portion of second connector contact 392b therein, and the portion of connector body 391 provided between passageways 393a and 393b may be operative to electrically isolate the portions of contacts 392 and 392b positioned respectively within passageways 393a and 393b. Although a particular shape of adapter mating structure 393 of connector body 391 may be shown, it is to be understood that adapter mating structure 393 may be any suitable shape that may be operative to protect and support contacts 392a and 392b and/or mate with any suitable connector mating structure of connector 210 (e.g., inlet 211) of assembly 200. Adapter mating structure 393 may be made from any suitable material, such as polycarbonate resin (e.g., Emerge™ PC 8600-10), or combination of materials that may be able to insulate and protect certain contents to be positioned therein and/or thereagainst.

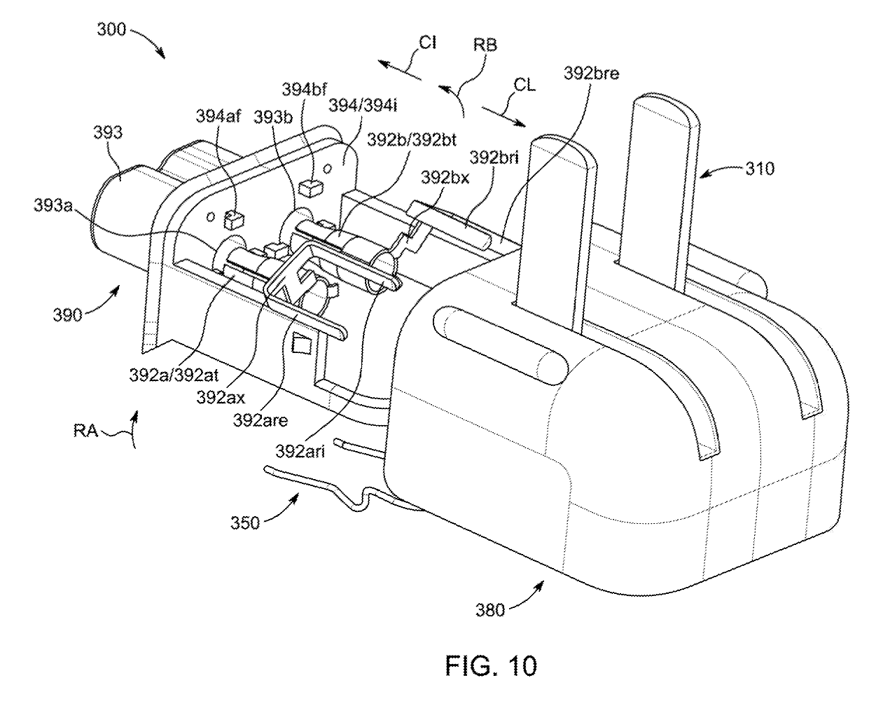

Connector 390 may include one or more power adapter connector contacts, such as contact 392a and contact 392b, each of which may include a first portion that is operative to be at least partially positioned within interior shell space 369 when assembly 300 is fully assembled (e.g., for electrical coupling to a portion of a respective one of contacts 312a and 312b of connector 310 of assembly 300) and a second portion that is operative to be accessible for electrical coupling by a respective one of contacts 212a and 212b of connector 210 of assembly 200 when assembly 300 is fully assembled. For example, as shown, first contact 392a may include a contact extender 392ax, a contact tube 392at extending in a first direction away from contact extender 392ax (e.g., a direction of arrow CI of FIG. 10), and at least one contact arm extending in a second direction away from contact extender 392ax (e.g., a direction of arrow CL of FIG. 10) (e.g., a direction opposite to the first direction)), such as an exterior contact arm 392are and an interior contact arm 392ari, while second contact 392b may include a contact extender 392bx, a contact tube 392bt extending in a first direction away from contact extender 392bx (e.g., a direction of arrow CI of FIG. 10), and at least one contact arm extending in a second direction away from contact extender 392bx (e.g., a direction of arrow CL of FIG. 10) (e.g., a direction opposite to the first direction)), such as an exterior contact arm 392bre and an interior contact arm 392bri. Each one of contacts 392a and 392b may be made of any suitable material or combinations of material that may conduct electricity (e.g., to conduct electricity from respective contacts of connector 310 to respective contacts of connector 210), including, but not limited to, brass, bronze, and/or the like.

Each one of contact tube 392at and contact tube 392bt may be any suitable shape and size operative to be electrically coupled to a respective one of contacts 212a and 212b of connector 210. For example, as shown, where each one of contacts 212a and 212b may be an electrically conductive pin, each one of contact tubes 392at and 392bt may be any suitable female electrical contact, such as a set of wings extending in a tubular shape, for receiving and engaging the electrically conductive pin for electrically one of contacts 392a and 392b to a respective one of contacts 212a and 212b. Each one of contact tubes 392at and 392bt may be at least partially positioned within a respective one of contact passageways 393a and 393b of adapter connector body 391 (e.g., through contact insertion in the direction of arrow CI of FIG. 10), such that, when adapter mating structure 393 of adapter connector body 391 of connector 390 may be mated within inlet mating structure 211 of connector 210, contact tube 392at may receive and be electrically coupled to contact 212a at least partially within passageway 393a and contact tube 392bt may receive and be electrically coupled to contact 212b at least partially within passageway 393b.

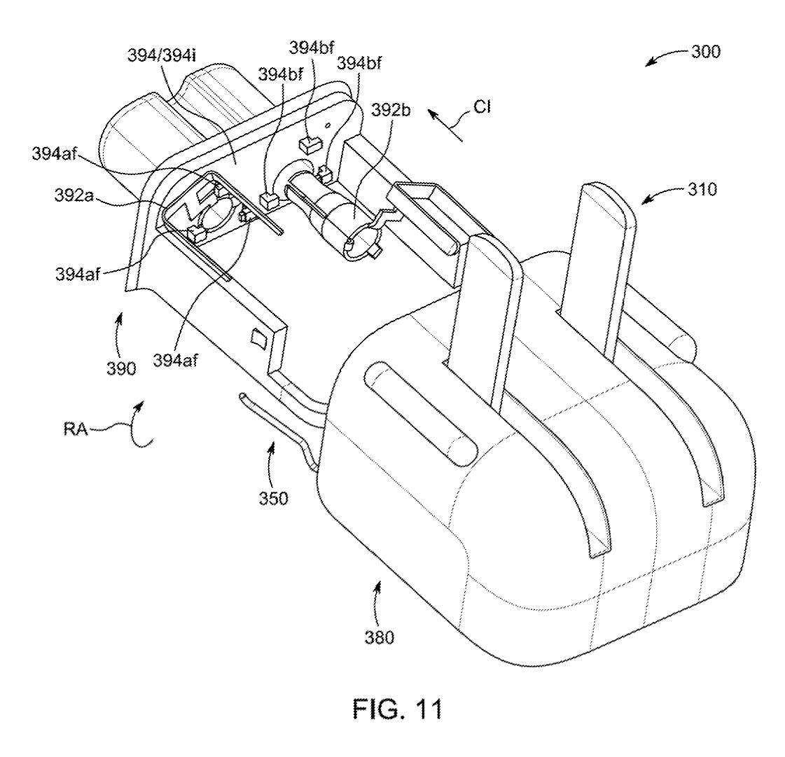

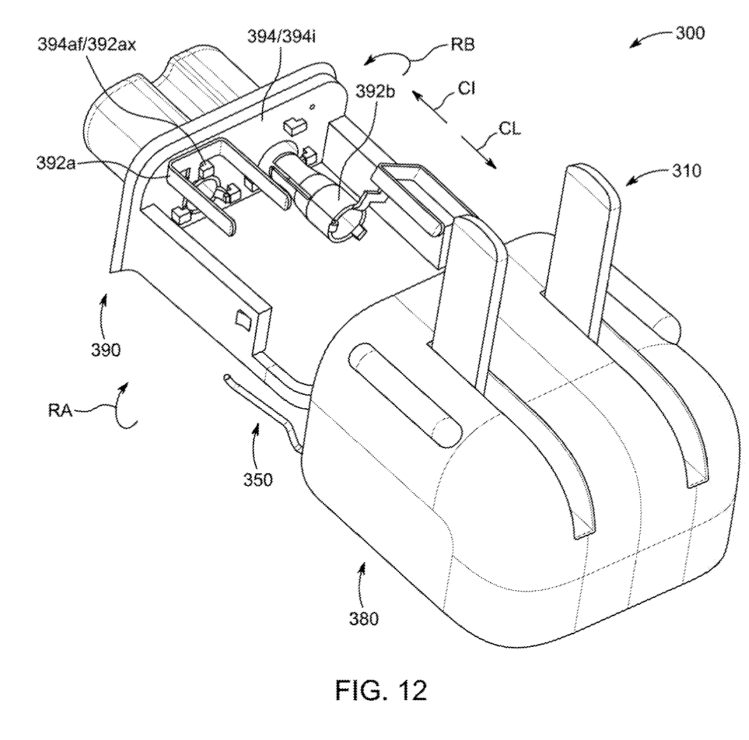

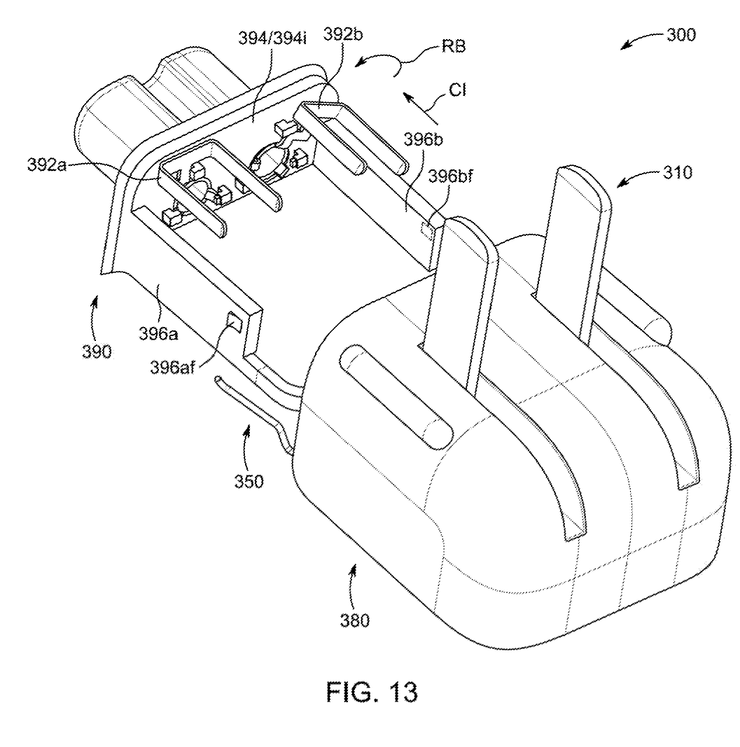

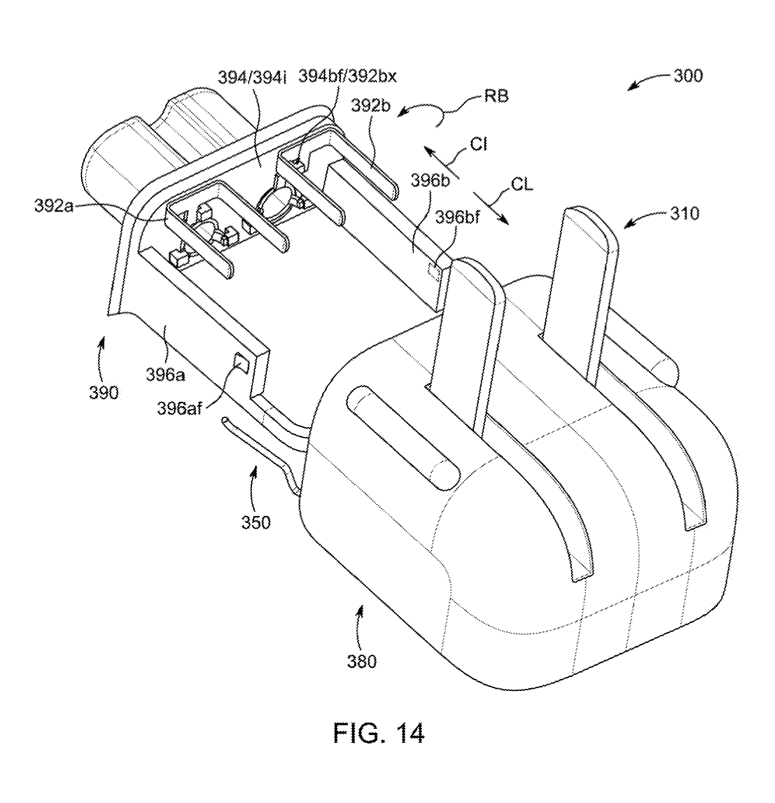

Each one of the contact extenders of contacts 392a and 392b may be any suitable shape and size operative to help fix its contact to adapter connector body 391 when assembly 300 is fully assembled. For example, as shown, contact extender 392ax may extend from contact tube 392at such that, when contact tube 392at has been inserted a particular amount into contact passageway 393a (e.g., in an insertion direction of arrow CI, from the configuration of FIG. 10 to the configuration of FIG. 11), contact extender 392ax may contact or otherwise interface with interior surface 394i of rear wall structure 394 for preventing contact 392a from being inserted any further into contact passageway 393a. Moreover, once contact tube 392at has been inserted into contact passageway 393a, contact 392a may be operative to be rotated with respect to connector body 391 to a locked position (e.g., in a rotation direction of arrow RA about the insertion direction of arrow CI, from the configuration of FIG. 11 to the configuration of FIG. 12) such that contact extender 392ax may interact with and be held by at least one contact retention feature 394af that may be extending from interior surface 394i of rear wall structure 394 in order to prevent contact tube 392at from being removed from contact passageway 393a (e.g., in order to prevent any movement of contact 392a with respect to adapter connector body 391 in a removal direction of arrow CL (e.g., a direction that may be opposite to the insertion direction of arrow CI)). As shown, in some embodiments, rear wall structure may be provided with at least three contact retention features 394af positioned at different locations about the periphery of contact passageway 393a to balance any stress that may be applied to contact extender 392ax if any force might attempt to pull contact 392a away from connector body (e.g., in the removal direction of arrow CL). Alternatively or additionally, as shown, contact extender 392bx may extend from contact tube 392bt such that, when contact tube 392bt has been inserted a particular amount into contact passageway 393b (e.g., in an insertion direction of arrow CI, from the configuration of FIG. 12 to the configuration of FIG. 13), contact extender 392bx may contact or otherwise interface with interior surface 394i of rear wall structure 394 for preventing contact 392b from being inserted any further into contact passageway 393b. Moreover, once contact tube 392bt has been inserted into contact passageway 393b, contact 392b may be operative to be rotated with respect to connector body 391 to a locked position (e.g., in a rotation direction of arrow RB about the insertion direction of arrow CI, from the configuration of FIG. 13 to the configuration of FIG. 14) such that contact extender 392bx may interact with and be held by at least one contact retention feature 394bf that may be extending from interior surface 394i of rear wall structure 394 in order to prevent contact tube 392bt from being removed from contact passageway 393b (e.g., in order to prevent any movement of contact 392b with respect to adapter connector body 391 in a removal direction of arrow CL (e.g., a direction that may be opposite to the insertion direction of arrow CI)). As shown, in some embodiments, rear wall structure may be provided with at least three contact retention features 394bf positioned at different locations about the periphery of contact passageway 393b to balance any stress that may be applied to contact extender 392bx if any force might attempt to pull contact 392b away from connector body 391 (e.g., in the removal direction of arrow CL).

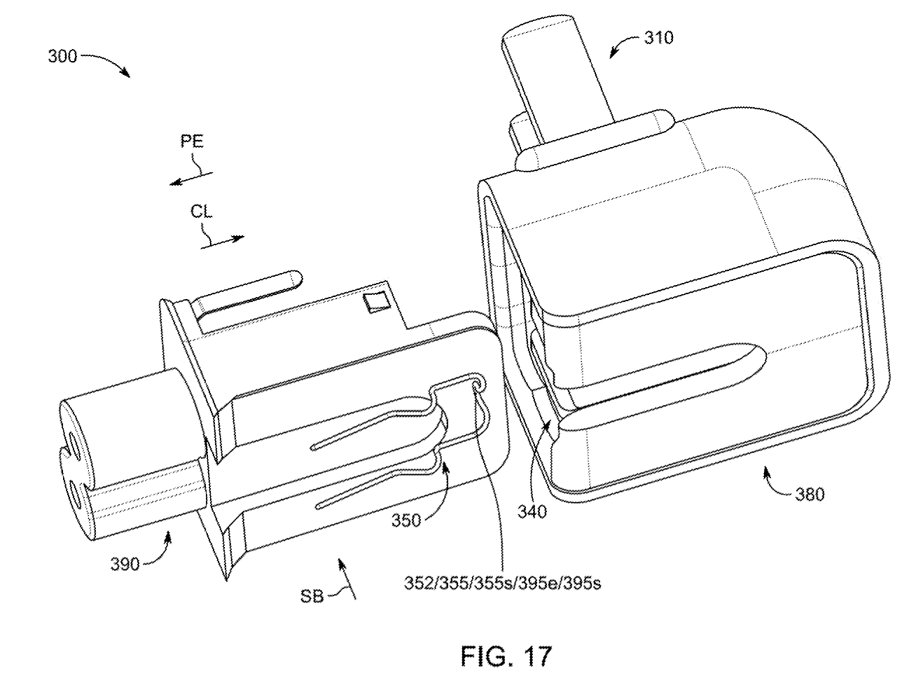

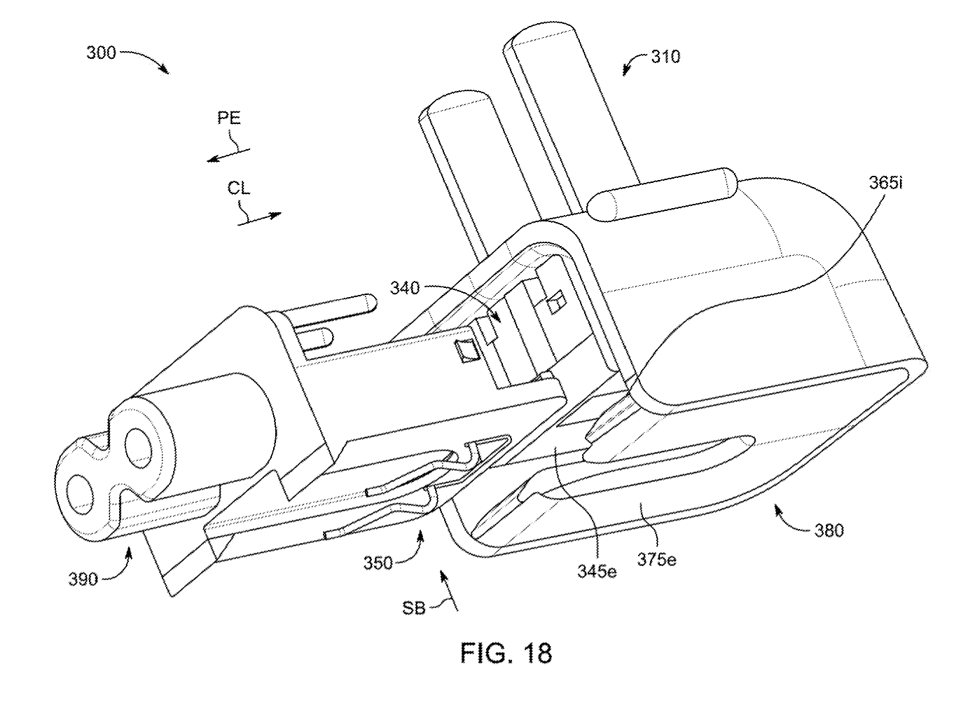

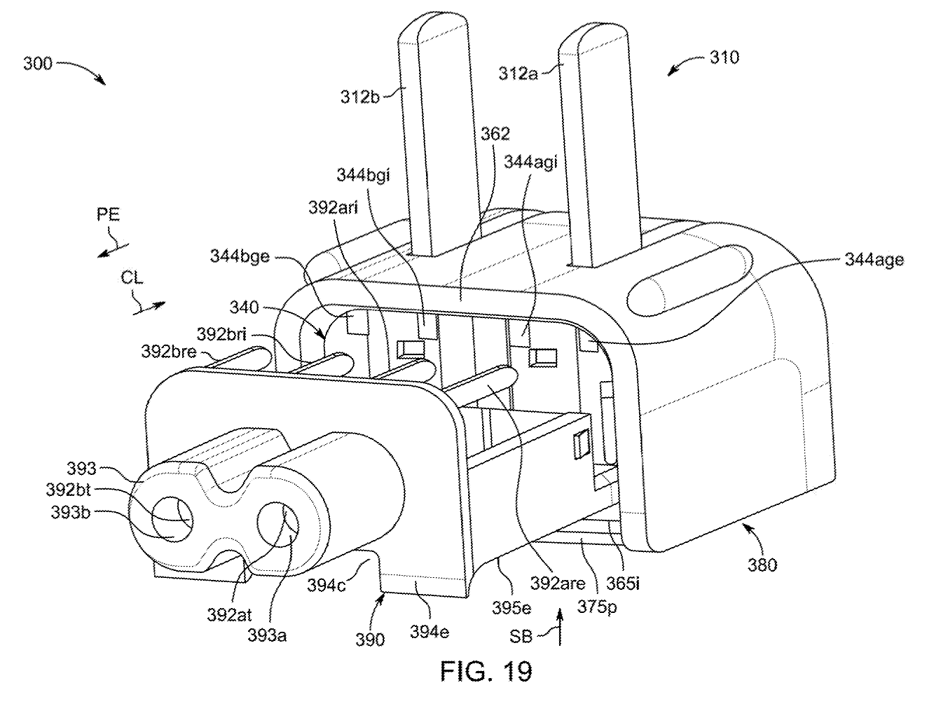

Each one of the contact arms of contacts 392a and 392b may be any suitable shape and size operative to be passed at least partially through a respective recess guide defined by body 340 and/or shell 380 and/or to be electrically coupled to a respective one of contacts 312a and 312b of connector 310 when assembly 300 is fully assembled. For example, as shown, where each one of contacts 312a and 312b may be an electrically conductive blade or prong with a contact axis extension extending from a main contact body, each one of contact arms 392are, 392ari, 392bre, and 392bri may be any suitable electrical contact operative to maintain contact or at least an electrical coupling with a respective contact axis extension despite that contact axis extension rotating about its axis or to maintain contact with a respective contact axis extension when the contact axis extension is in a particular rotated orientation (e.g., when contacts 312a and 312b have been rotated to their open position (e.g., their open position of FIG. 20)). For example, once each one of contacts 392a and 392b has been inserted into its respective one of contact passageways 393a and 393b and locked with respect to adapter connector body 391 (e.g., by one or more respective contact retention features 394af and 394bf), connector 390 may be at least partially inserted into interior space 369 of outer shell 380 (e.g., in the direction of arrow CL of FIGS. 14, 18, and 19) from the assembly configuration of FIG. 19 to the fully assembled assembly configuration of FIG. 20 for enabling the electrical coupling of connectors 310 and 390 (e.g., by inserting each one of contact arms 392are, 392ari, 392bre, and 392bri of connector 390 into a respective one of recess guides 344age, 344agi, 344bgi, and 344bge for accessing and electrically coupling to a respective one of contact axis extensions 316ae, 316ai, 316bi, and 316be of connector 310, where each one of contact axis extensions 316ae, 316ai, 316bi, and 316be may be positioned at least partially within and/or just beyond the end of a respective one of recess guides 344age, 344agi, 344bgi, and 344bge). Once assembly 300 is fully assembled, at least a portion of an interior surface of side wall structure 396a of connector body 391 may contact or at least lie adjacent to at least a portion of an exterior surface of side wall structure 346a of protection body 340 in between side wall structure 346a of protection body 340 and side wall structure 366a of outer shell 380, at least a portion of an interior surface of side wall structure 396b of connector body 391 may contact or at least lie adjacent to at least a portion of an exterior surface of side wall structure 346b of protection body 340 in between side wall structure 346b of protection body 340 and side wall structure 366b of outer shell 380, at least a portion of bottom wall structure 395 of connector body 391 may be positioned in between exterior surface 345e of bottom wall structure 345 of protection body 340 and at least a portion of an interior surface of bottom wall structure 385 of outer shell 380, and/or at least a portion of interior surface 394i of rear wall structure 394 of connector body 391 may contact or at least lie adjacent to at least a portion of an exterior surface of cap wall structure 344 of protection body 340, where rear wall structure 394 of connector 390 may combine with wall structures 385, 362, 364, 366a, and 366b of outer shell 380 to form an enclosure about protection body 340. Moreover, as mentioned, when assembly 300 is fully assembled and when contacts 312a and 312b are in their open position (e.g., their open position of FIG. 20), each one of contact arms 392are, 392ari, 392bre, and 392bri of connector 390 may access and be electrically coupled to a respective one of contact axis extensions 316ae, 316ai, 316bi, and 316be of connector 310 via a path through a respective one of recess guides 344age, 344agi, 344bgi, and 344bge.

Adapter connector body 391 of connector 390 may include one or more features operative to interact with one or more respective features of protection body 340 and/or one or more respective features of outer shell 380 for properly retaining adapter connector body 391 within interior space 369 of outer shell 380. For example, adapter connector body 391 may include any suitable side interaction snap features 396af and 396bf (e.g., a ramp or nub feature on an exterior surface of each one of first and second wall surfaces 396a and 396b of body 391) that may be operative to interact with (e.g., snap into) a respective one of interaction features 366af and 366bf of shell 380 (e.g., a recess within an interior surface of first side wall 366a and a recess within an interior surface of second side wall 366b of shell 380) when body 391 is inserted into space 369 of shell 380. Additionally or alternatively, one or more portions of a free end 395n of bottom wall structure 395 of body 391 may be operative to interact with (e.g., be retained between) one or more respective interaction features 366n of shell 380 (e.g., one or more projecting surfaces or nubs or shelves from an interior surface of shell 380) when body 391 is inserted into space 369 of shell 380. Additionally or alternatively, one or more features 394sf of interior surface 394i of cap wall structure 394 of body 391 (e.g., flanges, etc.) may be operative to interact with (e.g., contact and press against) one or more respective features 366sf of shell 380 (e.g., one or more lips or recessed rims extending about at least a portion of rear opening 367) when body 391 is at least partially inserted into space 369 of shell 380. Any suitable number and/or types of respective interaction features may be provided by any suitable portions of body 391 and protection body 340 and/or shell 380 at any suitable locations for interacting with each other within interior space 369 for at least partially retaining body 391 at an appropriate location within space 369. Additionally or alternatively, any suitable adhesion technique (e.g., glue) may be used to hold body 391 in its functional position with respect to protection body 340 and/or shell 380 at least partially within interior space 369.

As shown in FIGS. 17 and 18, for example, prior to inserting connector 390 into interior space 369 for retention therein, gap spring 350 of assembly 300 may be positioned against adapter connector body 391 such that spring 350 may also be retained within interior space 369. Spring 350 may be any suitable spring or combination of two or more springs that may be operative to be held at least partially within interior space 369, about at least a portion of contact slot 385c, between any two suitable contact structures, such as an interior surface of bottom wall 385 of shell 380 and any other suitable contact structure that may be held within interior space 369, such as exterior surface 395e of bottom wall 395 of connector 390 and/or exterior surface 345e of bottom wall 345 of protection body 340 (e.g., if connector body 391 of connector 390 was not provided with a bottom wall). Such a positioning of gap spring 350 of assembly 300 within interior space 369 may enable any suitable structure remote from assembly 300 to be inserted into interior space 369 (e.g., a connector mating structure (e.g., contact 212c) of connector 210 of assembly 200) via contact slot 385c in order to be at least partially positioned between a portion of gap spring 350 and at least one of the spring's contact structures of assembly 300 (e.g., at least one of bottom wall 385, bottom wall 395, and bottom wall 345) for tightly holding that remote structure against assembly 300.

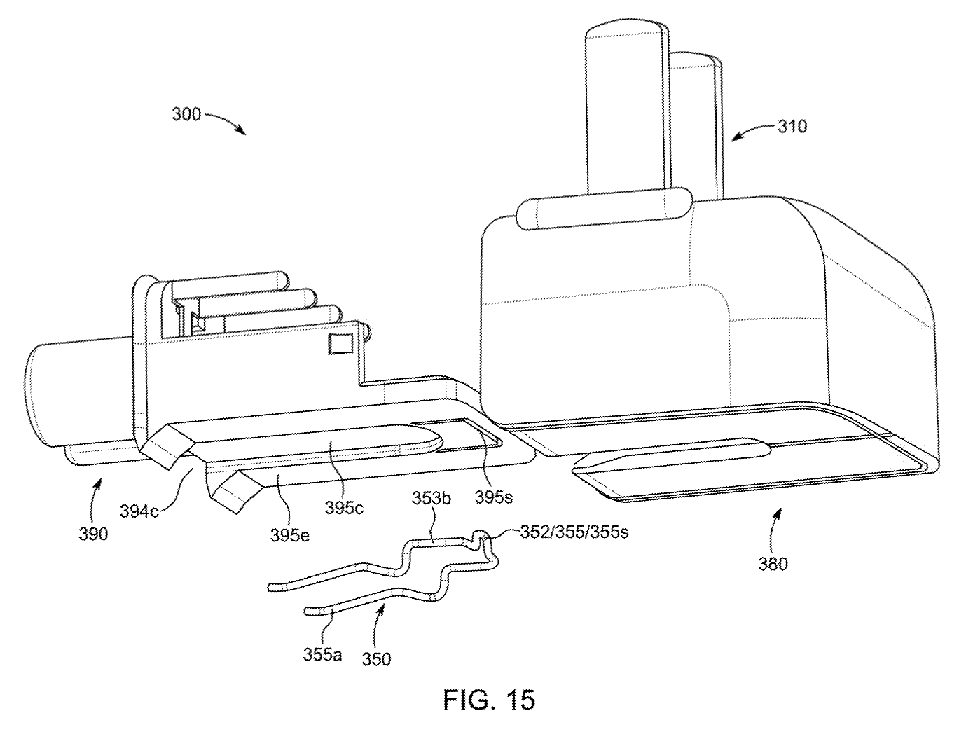

As just one example, as shown, spring 350 may include at least a first spring body 352, where spring body 352 may include a first spring arm 353a extending between a free end 351a and a first connector end 355a of a connector portion 355, and a second spring arm 353b extending between a free end 351b and a second connector end 355b of connector portion 355 that may be opposite first end 355a of connector portion 355. When no external pressure is exerted onto spring body 352, the shape of first spring arm 353a may be configured to include not only a peak 353ap between free end 351a and first connector end 355a but also a trough 353at between peak 353ap and first connector end 355a, while, similarly, the shape of second spring arm 353b may be configured to include not only a peak 353bp between free end 351b and second connector end 355b but also a trough 353bt between peak 353bp and first connector end 355b. Spring body 352 may be provided by any suitable material or combination of materials, including, but not limited to, stainless steel (e.g., spring steel (e.g., with a diameter SBD (e.g., with a magnitude in a range of about 0.5 millimeters to 0.6 millimeters))). As shown (e.g., in FIGS. 15-17), at least a portion of spring body 352 (e.g., at least a portion of connector portion 355 and/or at least a portion of spring arm 353a adjacent connector end 355a and/or at least a portion of spring arm 353b adjacent connector end 355b) may be positioned and held against exterior surface 395e of bottom wall 395 of adapter connector body 391 (e.g., in the direction of arrow SB) such that connector 390 may be inserted into interior space 369 along with spring 350 (e.g., in the direction of arrow CL). In some particular embodiments, as shown, a spring recess 395s may be provided in exterior surface 395e of bottom wall 395 of adapter connector body 391, such that at least a portion of spring body 352 may be positioned within spring recess 395s during insertion of connector 390 and spring 350 into interior space 369. Moreover, in some embodiments, as shown, spring recess 395s may have a variable depth not only to receive and make contact with a raised connector feature 355s of connector portion 355 (e.g., by a height RCH (e.g., with a magnitude in a range of about 1.1 millimeters to 1.3 millimeters)) at a deep portion of spring recess 395s but also to receive and make contact with two substantially flat portions of connector portion 355 that may extend from either side of connector feature 355s to a respective one of connector ends 355a and 355b. By enabling contact between spring body 352 and adapter connector body 391 along a variable depth of spring recess 395s and along a variable height of spring connector portion 355s, such interaction between spring body 352 and adapter connector body 391 may help facilitate insertion of connector 390 together with spring 350 into interior space 369 for fully assembling assembly 300 despite any contact spring 350 may make with outer shell 380 during such insertion (e.g., contact between one or more of free ends 351a and 351b of spring 350 and bottom wall 385 of outer shell 380 during insertion of connector 390 and spring 350 into interior space 369 of shell 390 in the direction of arrow CL) and/or such interaction between spring body 352 and adapter connector body 391 may help facilitate removal of spring 350 with connector 390 from interior space 369 (e.g., during a break event, such as a first break event that may pull connector 390 away from connector 310 and shell 380 in the direction of arrow PE (e.g., a direction that may be opposite to the direction of arrow CL)) despite any contact spring 350 may make with outer shell 380 during such removal. Another recess, such as contact recess 395c may also be provided in exterior surface 395e of bottom wall 395 of adapter connector body 391 (e.g., adjacent spring recess 395s), such that at least a portion of spring arms 353a and 353b may be positioned therein or at least thereunder during insertion of connector 390 and spring 350 into interior space 369. Contact recess 395c may extend to and be fluid with a contact recess 394c that may be provided through cap wall structure 394 of connector body 391.

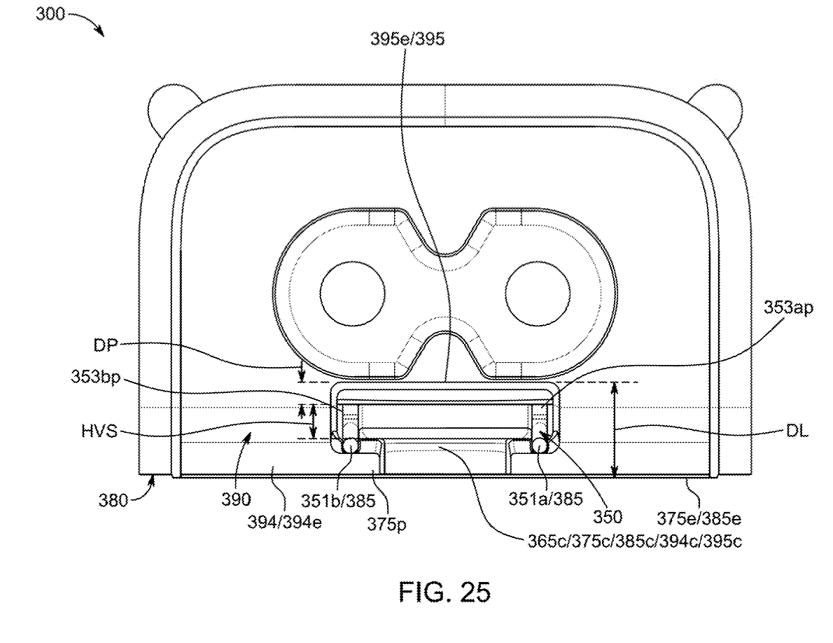

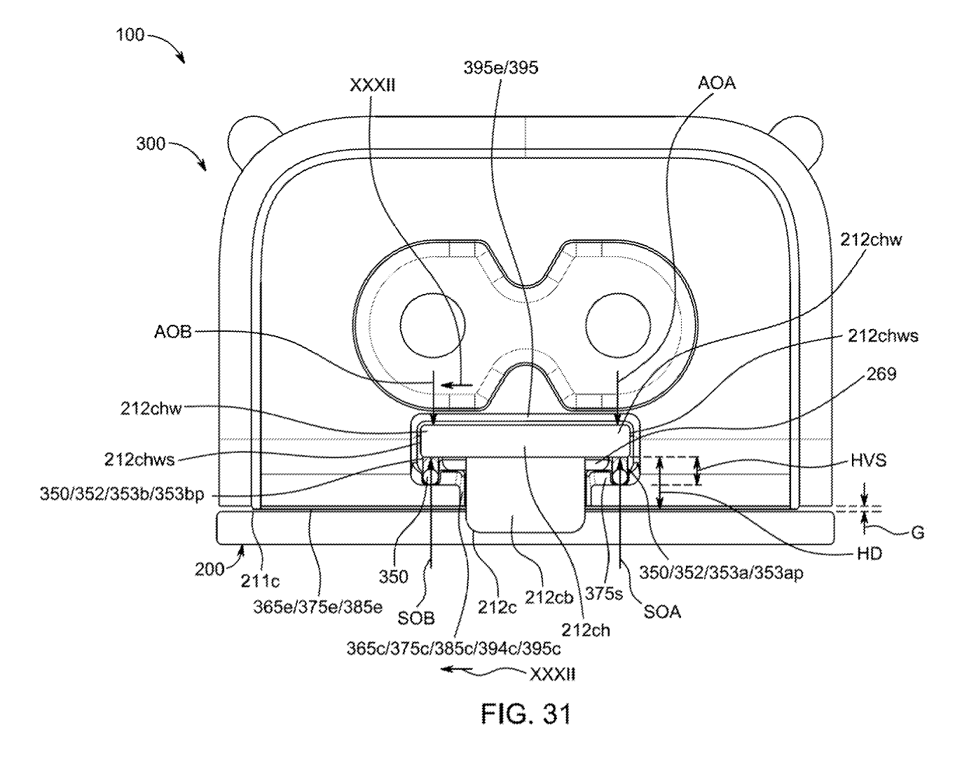

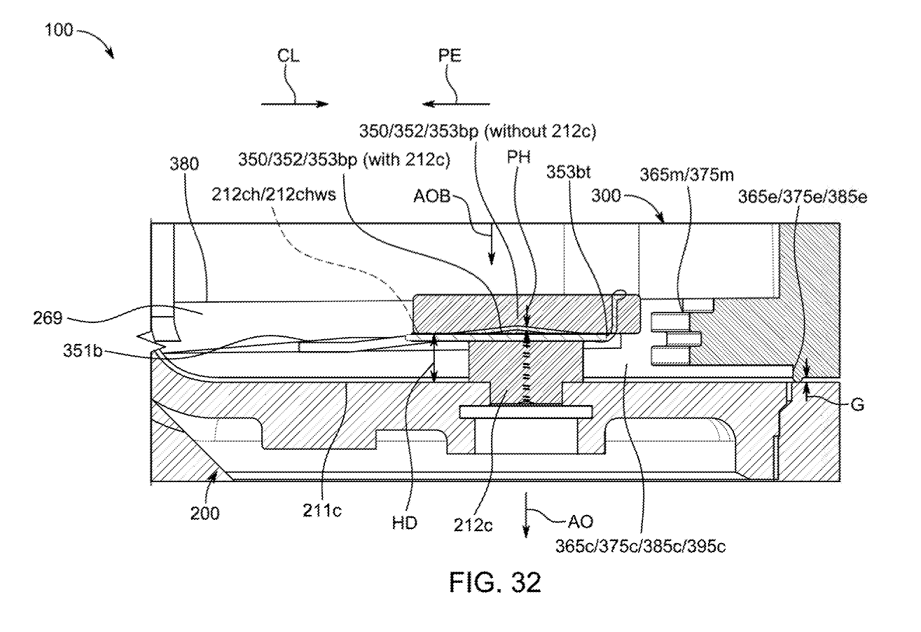

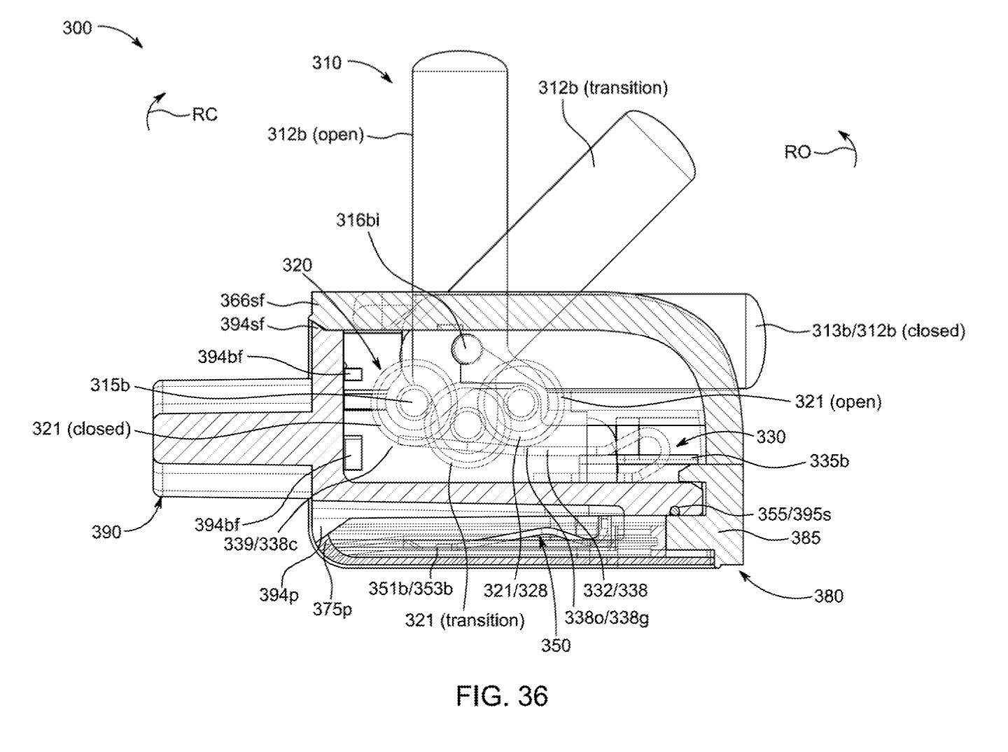

When assembly 300 has been fully assembled with spring 350 positioned within interior space 369, spring connector portion 355 of spring 350 may be held between two contact structures of assembly 300 (e.g., between an exterior surface of bottom wall 395 of adapter connector body 391 (e.g., within recess 395s) and an interior surface of bottom wall 385 of outer shell 380 (e.g., as shown in FIG. 36)), while free ends 351a and 351b of spring 350 may be biased against or held proximate to a portion of an interior surface of bottom wall 385 of outer shell 380 (e.g., as shown in FIGS. 25 and 36). For example, as shown, free ends 351a and 351b of spring 350 may be biased against or held proximate to a support feature 375s of interior surface 375i of bottom wall 385 of shell 380 that may extend along at least a portion of the periphery of contact slot 385c. Spring 350 may be configured to have a height SSH between its free ends 351 and the bottom of connector portion 355 in the relaxed state of spring body 352 for being held between its two contact structures, where height SSH may be any suitable magnitude appropriate for the assembly 300 within which it is to be used (e.g., a magnitude in a range of about 2.26 millimeters to 2.46 millimeters). A sloped ramp portion 375r may be provided at each end of support feature 375s (e.g., on either side of the entrance to contact slot 385c) for facilitating smooth insertion of connector 390 and spring 350 into interior space 369 without an abrupt rear edge of bottom wall 385 for spring free ends 351a and 351b to snag on. Then, once connector 390 and spring 350 are positioned within interior space 369 of outer shell 380, contact recess 394c may enable any suitable structure remote from assembly 300 to be inserted into interior space 369 (e.g., a connector mating structure (e.g., contact 212c) of connector 210 of assembly 200) through contact recess 394c and along contact recess 395c and contact slot 385c in order to be at least partially positioned between a portion of gap spring 350 and at least one of the spring's contact structures of assembly 300 (e.g., at least one of bottom wall 385, bottom wall 395, and bottom wall 345) for tightly holding that remote structure against assembly 300. For example, as shown in FIGS. 31 and 32, once assembly 300 is fully assembled, at least a portion of connector mating structure 212c of assembly 200 may be inserted into interior space 369 of assembly 300 (e.g., in the direction of arrow CL) via contact recess 394c and along contact slot 385c. As shown, connector mating structure 212c may include a base portion 212cb extending out from exterior surface 211c of assembly 200 and a head portion 212ch coupled to the top of base portion 212cb.

The cross-sectional shape of head portion 212ch may be greater than the cross-sectional shape of base portion 212cb such that a wing portion 212chw of head portion 212ch may extend beyond the periphery of base portion 212cb. Therefore, for example, connector mating structure 212c may be shaped similarly to a mushroom head or a nail or the like. While head portion 212ch may be sized to fit through a portion of contact recess 394c of cap wall structure 394 and into a portion of interior space 369 between adapter connector body 391 and bottom wall structure 385 of outer shell 380, head portion 212ch may be too large to fit through contact slot 385c of bottom wall structure 385, such that only base portion 212cb may extend through contact slot 385c. Therefore, the relative geometries of connector mating structure 212c and assembly 300 may be configured such that contact recess 394c of cap wall structure 394 and contact slot 385c through bottom wall 385 of shell 380 may be used to insert head portion 212ch of connector mating structure 212c into interior space 369 of assembly 300 in the direction of arrow CL but also such that at least support feature 375s of interior surface 375i of bottom wall 385 of shell 380 may be used to prevent or at least resist removal of head portion 212ch of connector mating structure 212c from interior space 369 through contact slot 385c (e.g., in the direction of arrow AO). In other embodiments (not shown), a portion of slot 385c may be sized to fit head portion 212ch therethrough (e.g., in the direction of arrow SB) and then base portion 212cb may be slid along slot 385c (e.g., in the direction of arrow CL) to another portion of slot 385c that may be sized (as shown) not to fit head portion 212ch therethrough, such that contact recess 394c may not be necessary and such that slot 385c may not extend to an edge of bottom wall 385.

Once inserted into interior space 369 of assembly 300, at least a portion of wing portion 212chw of head portion 212ch extending beyond the periphery of base portion 212cb may be positioned between a top contact structure for spring 350 (e.g., exterior surface 395e of bottom wall structure 395 of adapter connector body 391 (e.g., contact recess 395c)) and a portion of each spring arm of spring 350 (e.g., peak 353ap of spring arm 353a and peak 353bp of spring arm 353b). For example, as shown, a bottom surface 212chws of wing portion 212chw of head portion 212ch extending beyond the periphery of base portion 212cb may contact peak 353ap of gap spring arm 353a and peak 353bp of gap spring arm 353b when connector mating structure 212c has been inserted into interior space 369, while a top surface of head portion 212ch may contact a surface of body 391 within interior space 369 (e.g., exterior surface 395e of bottom wall structure 395 of adapter connector body 391 (e.g., contact recess 395c)) and/or a bottom surface of body 340 (e.g., surface 345e of wall 345). Due to a distance HD between exterior surface 211c of assembly 200 and bottom surface 212chws of wing portion 212chw of head portion 212ch extending beyond the periphery of base portion 212cb being fixed, bottom surface 212chws of wing portion 212chw may provide downward force on spring arms 353a and 353b at peaks 353ap and 353bp (e.g., respective downward forces in the direction of arrows AOA and AOB), which may reduce the height of the peak of each spring arin (e.g., with respect to the free end of each spring arm (e.g., to reduce the height of peak 353bp by a distance PH (e.g., as shown in FIG. 32))) and/or to push an exterior surface of assembly 300 (e.g., an exterior surface 385e of bottom wall structure 385) towards (e.g., against) exterior surface 211c of assembly 200 (e.g., to reduce the magnitude of any gap G therebetween). By configuring the spring characteristics of spring 350, the distance DP between exterior surface 395e of bottom 395 of body 391 and peaks 353ap/353bp of spring 350 within interior space 369 prior to the insertion of connector mating structure 212c therein (e.g., as shown in FIG. 25), and/or the distance DL between exterior surface 395e of bottom 395 of body 391 and exterior surface 385e of outer shell 380 (e.g., as shown in FIG. 25), with respect to the expected fixed distance HD of connector mating structure 212c in a particular manner, spring 350 may be operative to always exert some counter force onto bottom surface 212chws of wing portion 212chw of connector mating structure 212c when connector mating structure 212c is inserted into interior space 369 (e.g., forces in the direction of arrows SOA and SOB, which may be counter to the forces applied by bottom surface 212chws of wing portion 212chw of connector mating structure 212c onto spring 350 in the direction of respective arrows AOA and AOB). This may enable the interaction between connector mating structure 212c of assembly 200 and spring 350 of assembly 300 to provide a gapless fit between bottom surface 212chws of wing portion 212chw and spring 350 for reducing gap G (e.g., to 0) when head portion 212ch of connector mating structure 212c is inserted into interior space 369 of assembly 300. Assembly 300 may be configured such that spring 350 may constantly pull an exterior surface of assembly 300 (e.g., an exterior surface 385e of bottom wall structure 385) towards exterior surface 211c of assembly 200 (e.g., to reduce the magnitude of any gap G therebetween (e.g., to 0)) using head portion 212ch of connector mating structure 212c. Spring 350 may be operative to eliminate any gap or fluctuation in space between assembly 300 and head portion 212ch of connector mating structure 212c when head portion 212ch of connector mating structure 212c may be inserted into interior space 369. The magnitude of a height HVS (e.g., of FIGS. 25, 31, and 35), which may be a height between each one of arm peaks 353ap/353bp against which head portion 212ch of connector mating structure 212c may press and support feature 375s on which arm troughs and/or free ends of spring 350 may press, may vary between a first magnitude when spring 350 is in a relaxed state (e.g., before any connector mating structure is introduced into interior space 369 (e.g., height HVS of FIGS. 25 and 35)) and any one of many shorter second magnitudes when compressed by assembly 200 (e.g., as shown in FIG. 31) based on a variable magnitude of distance HD of assembly 200. Therefore, spring 350 may be compressible to adapt to one of many possible distances HD of assembly 200 for ensuring a constant force by assembly 200 on spring 350 for minimizing the magnitude of or removing gap G.

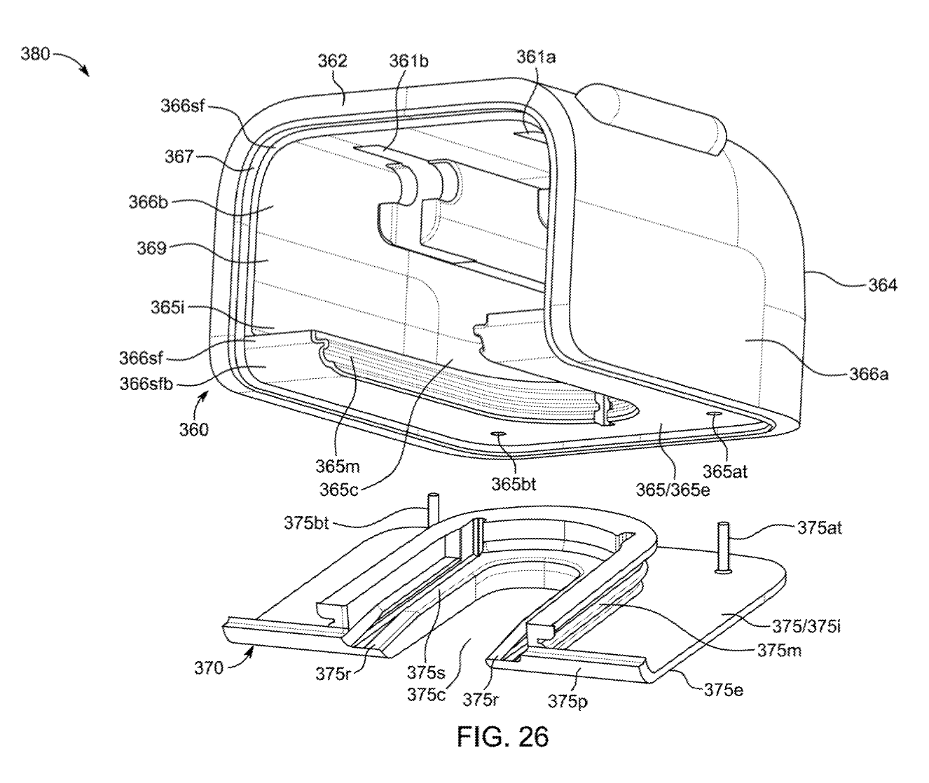

Outer shell 380 may be formed in any suitable manner. For example, outer shell 380 may be formed using any suitable molding process, such as a single shot molding process that may create the entirety of outer shell 380 with the same material in a single process such that the entire outer shell 380 may be provided as a robust and seamless and unitary structure. Alternatively, outer shell 380 may be formed by a multiple-shot molding process, which may include a first shot molding process that may be operative to create the entirety of first outer shell structure 360 (e.g., as independently shown in FIG. 26) and a second shot molding process that may be operative to create the entirety of second outer shell structure 370 (e.g., as independently shown in FIG. 26), where the two different shots may be carried out using the same or different material for forming the different shell structures, or any material with at least one characteristic that may change between the two different shots (e.g., the color of the material used may be altered between the two different shots (e.g., for cosmetic purposes)). In such embodiments, each one of shell structures 360 and 370 may be provided as a robust and seamless and unitary structure. In some embodiments, in such a multi-shot process, the second shot molding process for forming second outer shell structure 370 may be done independently of the first shot molding process for forming first outer shell structure 360, and then the two structures may be combined together to form the structure of shell 380 (e.g., by snap fitting or gluing or otherwise coupling together structures 360 and 370 (e.g., by inserting structure 370 in the direction of arrow CL towards structure 360)). Alternatively, in such a multi-shot process, the second shot molding process for forming second outer shell structure 370 may be done after the first shot molding process for forming first outer shell structure 360 in an over mold or double shot molding process or any other suitable multi-material injection molding process, such that the second shot molding process may result in the creation of the final structure of outer shell 380. In any event, the resulting structure of such a multi-material injection molding process may result in a unibody structure providing outer shell 380. First outer shell structure 360 and/or second outer shell structure 370 of outer shell 380 may be formed using any suitable material(s) using any suitable techniques. For example, first outer shell structure 360 may be molded (e.g., injection molded) using any suitable material (e.g., a polycarbonate resin (e.g., Emerge™ PC 8600-10)), while second outer shell structure 370 may be molded (e.g., molded and then coupled (e.g., ultrasonically welded) to first outer shell structure 360 or over molded onto first outer shell structure 360) using any suitable material (e.g., a polycarbonate resin (e.g., Emerge™ PC 8600-10)). Shell 380 may be a unibody (e.g., unit body or unitary construction design body) five-sided box-like structure (e.g., as a result of a single or multi-shot (e.g., sequential injection) or multi-component (e.g., co-injection) molding process or as a result of an over-molding process for forming structures 360 and 370 as shell 380). Structure 360 may differ from structure 370 with respect to any suitable characteristic, such as size, shape, color, flexibility, deformability, tactility, ability to repel certain fluids, and/or the like. Alternatively, structure 360 and structure 370 may be formed from the same material. Additionally or alternatively, the manner(s) in which structure 360 may be formed may be the same as or different than the manner(s) in which structure 370 may be formed.

When outer shell 380 may be formed by combining first outer shell structure 360 with second outer shell structure 370, the different structures may be formed in order to provide certain cosmetic features and/or to limit the negative effects of certain break events that may occur between certain portions of system 100. As shown, in such embodiments, first outer shell structure 360 may be formed to provide top wall 362, front wall 364, side wall 366a, and side wall 366b, along with one, some, or all of features 361a, 361b, 366af, 366bf, 3366sf, 66ar, 366br, 366at, 366bt, 366ae, 366ai, 366bi, 366be, 366n, and 366u. Additionally, first outer shell structure 360 may be formed to provide a bottom wall structure 365 with an interior surface 365i and an exterior surface 365e, where bottom wall structure 365 may extend between bottom portions of walls 366a, 366b, and 364, such that walls 362, 364, 365, 366a, and 366b of first outer shell structure 360 together may form a five-sided box structure defining a majority or the entirety of interior shell space 369 (e.g., along with opening 367). A contact slot 365c may be provided through bottom wall 365, and rear opening 367 (e.g., absence of a rear wall for forming a six-sided box) may provide access to interior shell space 369. Additionally or alternatively, bottom wall structure 365 may provide one or more features 366sfb (e.g., one or more lips or chamfers or the like) at an intersection of exterior surface 365e and a rear face of bottom wall structure 365. In some embodiments, one or more mating features 365m of any suitable type may be provided by the structure of bottom wall 365, such as along a portion of the structure of bottom wall 365 extending between surfaces 365i and 365e that may define the periphery of contact slot 365c (e.g., one or more ridges, flanges, ribs, notches, and/or the like), where such one or more features 365m may be operative to interact (e.g., mate) with one or more features of second outer shell structure 370 (e.g., features 375m) for presenting the two outer shell structures in a combined fashion as a robust outer shell 380 (e.g., during a snap-fitting or adhering or second molding process). Additionally or alternatively, one or more mating features, such as mating features 365at and 365bt, of any suitable type may be provided through at least a portion of the structure of bottom wall 365, such as a passageway through exterior surface 365e and towards if not also through interior surface 365i of bottom wall 365, where such one or more features 365at and 365bt may be operative to interact (e.g., mate (e.g., receive)) with one or more features of second outer shell structure 370 (e.g., features 375at and 375bt) for presenting the two outer shell structures in a combined fashion as a robust outer shell 380 (e.g., during a second molding process).

Moreover, as shown, second outer shell structure 370 may be formed to provide a bottom wall structure 375 with an interior surface 375i and an exterior surface 375e. A contact slot 375c may be provided through bottom wall 375. A portion of interior surface 375i may provide support feature 375s that may extend along at least a portion of the periphery of contact slot 375c, and/or may provide sloped ramp portion 375r that may be provided at each end of support feature 375s (e.g., on either side of the entrance to contact slot 375c). In some embodiments, one or more mating features 375m of any suitable type may be provided by the structure of bottom wall 375, such as above a majority of interior surface 375i along and about support feature 375s and contact slot 375c (e.g., one or more outwardly facing ridges, flanges, ribs, notches, and/or the like), where such one or more features 375m may be operative to interact (e.g., mate) with one or more features of first outer shell structure 360 (e.g., features 365m) for presenting the two outer shell structures in a combined fashion as a robust outer shell 380 (e.g., during a snap-fitting or adhering or second molding process). Additionally or alternatively, one or more mating features, such as mating features 375at and 375bt, of any suitable type may be provided to extend from at least a portion of the structure of bottom wall 375, such as a rod extending upwardly from interior surface 375i, where such one or more features 375at and 375bt may be operative to interact (e.g., mate (e.g., reside inside)) one or more features of second outer shell structure 370 (e.g., features 365at and 365bt) for presenting the two outer shell structures in a combined fashion as a robust outer shell 380 (e.g., during a second molding process). Therefore, bottom wall 385 (and its interior and exterior surfaces) may be provided by a combination of different portions of bottom wall 365 (and, respectively, its interior and exterior surfaces) and bottom wall 375 (and, respectively, its interior and exterior surfaces), and contact slot 385c may be provided by a combination of slot 365c and slot 375c.

Bottom wall structure 375 may provide one or more features 375p (e.g., one or more lips or chamfers or the like) at an intersection of exterior surface 375e and a rear face of bottom wall structure 375, which may be operative to cover at least a portion of one or more features 366sfb of bottom wall 365 of structure 360 when structures 360 and 370 combine to form outer shell 380. As shown in FIGS. 19-25, for example, when connector 390 is coupled to outer shell 380, a bottom portion 394p on interior surface 394i of cap wall structure may be operative to interface with a portion of features 375p of bottom wall structure 375, while a portion of exterior surface 394e of cap wall structure 394 of adapter connector body 391 may abut a top portion of features 375p of bottom wall structure 375 to combine to provide a rear face of assembled assembly 300. In some embodiments, the color of the material(s) forming structure 370 may match the color of the material(s) forming at least exterior surface 394e of cap wall structure 394 and/or coupler structure 393 and/or exterior surface 395e of bottom wall structure 395 of adapter connector body 391 such that structure 370 may appear to be the same as at least the portion of adapter connector body 391 that may be visible to a user during use of assembled assembly 300 (e.g., as shown in FIG. 25), despite the majority of the rear face of assembly 300 (i.e., exterior surface 394e and coupler structure 393) being provided by a completely different structure than the majority of the bottom face of assembly 300 (e.g., exterior surface 385e of outer shell 485).

In any event, outer shell 380 may be a robust unibody for providing a five-sided box structure defining interior shell space 369, such that at least bottom wall structure 365 of bottom wall structure 385, if not also bottom wall structure 375 providing an exterior surface 385e of shell 380, may be robustly constructed with side walls 366a and 336b, front wall 364, and top wall 362. This construction may greatly reduce the likelihood of bottom wall structure 385 being removed from the other wall structures of shell 380 during a potential break event, such as a break event that may attempt to pull head portion 212ch of contact connector mating structure 212c out from interior space 369 in the direction of arrow AO (e.g., due to a kick event on system 100 in the direction of arrow BE or PE or AO or otherwise when connector 210 is coupled to connector 390 and connector 310 is electrically coupled to socket connector 90). Instead, shell 380 may be robust to withstand such an attempted break event due to bottom wall 385 being unibody with the other walls of shell 380. Alternatively, shell 380 may be operative such that bottom wall 375 may release from bottom wall 365 of bottom wall 385 such that bottom wall 365 may remain with the remainder of outer shell 380 and only bottom wall 375 or a portion thereof may break off from assembly 300 during such a break event. Alternatively, only a portion or all of support feature 375s of bottom wall portion 375 of bottom wall 385 of shell 380 may be damaged (e.g., bend or deform) during such a break event to release head portion 212ch from interior space 369. In any event, at least a portion of bottom wall 385 may be operative to remain with other walls of shell 380 during such a break event, which may protect other components within interior space 369, such as connector 390, protection body 340, spring 330, bridge 320, and connector 310. Moreover, because adapter connector body 391 may not provide any portion of the bottom wall of shell 380, adapter connector body 391 may not be pulled out from interior space 369 in the direction of arrow AO during such a break event, but may remain for protecting contact 392a and contact 392b and protection body 340 and spring 330 and bridge 320 and connector 310 within interior space 369. Particularly, this may prevent any portion of contact 312a and/or contact 312b of connector 310 that may be residing within interior space 369 from being accessible to a user after such a break event (e.g., via the bottom of shell 380). Therefore, unlike some embodiments where a portion of adapter connector body 391 might provide the bottom wall of housing 301, for example, where such an adapter connector body may be welded or glued to a distinct four-sided box with side walls and top wall and front wall for providing a bottom wall and a rear wall, which might cause the entirety of connector body 391 to break away from the four-sided box during such a break event, by constructing at least bottom wall 365 of shell 380 to be robustly provided with the other walls of shell 380 (e.g., as a unibody five-sided box), assembly 300 may prevent bottom wall 385 from breaking away from the remainder of shell 380 during a potential break event. Therefore, assembly 300 may be operative to create a mechanical fuse for head portion 212ch of contact connector mating structure 212c.

Additionally or alternative, the construction of assembly 300 may greatly reduce the likelihood of any connector contacts of assembly 300 within interior space 369 from being accessible to a user during any other potential break event, such as a break event that may attempt to pull connector 390 out from interior space 369 in the direction of arrow PE (e.g., due to a kick event on system 100 in the direction of arrow BE or PE or AO or otherwise when connector 210 is coupled to connector 390 and connector 310 is electrically coupled to socket connector 90). Instead, as mentioned (e.g., with respect to FIGS. 30 and 37), protection body 340 may be operative to protect connector 310 from being accessible within interior space 369 of shell 380 by a user. For example, if a break event were able to pull adapter connector body 391 out from, or at least partially out from, interior space 369 in the direction of arrow PE (e.g., as shown in FIG. 29), no portion of contact 312b or of contact 312a within interior space 369 (e.g., no portion of any one or more of bases 314a and 314b, bridge extensions 315a and 315b, and/or axis extensions 316be, 316bi, 316ai, and 316ae of contacts 312a and 312b) would be accessible to a user, as protection body 340 may either completely block access to such contacts or may limit access to such contacts via narrow and/or lengthy recess guides 344age, 344agi, 344bgi, and 344bge (e.g., guide shapes configured to be accessible only by narrow and/or long contact arms 392are, 392ari, 392bri, and 392bre). Therefore, the recess guides may be used to hide and/or otherwise protect live portions of connector 310 within interior space 369 such that they cannot be touched by a user during various potential break events. Protection body 340 may be operative to at least partially surround or otherwise protect and/or insulate the contact portions within interior space 369. In some embodiments, as mentioned, at least a portion or the entirety of protection body 340 may be provided as a portion of outer shell 380 (e.g., formed as a portion of structure 380 (e.g., formed as a portion of structure 360 and/or as a portion of structure 370)), rather than independently forming body 340 and then inserting body 340 into space 369 of shell 380.

Moreover, if a break event were able to pull adapter connector body 391 out from, or at least partially out from, interior space 369 in the direction of arrow PE (e.g., as shown in FIG. 29), no portion of contact 392a or of contact 392b of connector 390 would remain electrically coupled to a respective one of contacts 312a and 312b and be accessible to a user. For example, as shown in FIG. 37, when assembly 300 is fully assembled, the free end tip of contact arm 392bri of contact 392b may only need to travel a distance LV in the direction of arrow PE to no longer be in position to be electrically coupled to contact axis extension 316bi of contact 312b, where distance LV may be less than or equal to or not substantially greater than a thickness TK of rear wall structure 394 extending between interior surface 344i and exterior surface 344e within interior space 369 of shell 380 when assembly 300 is fully assembled, such that when connector 390 is removed from interior space 369 in the direction of arrow PE, each one of contacts 392a and 392b will be electrically decoupled from a respective one of contacts 312a and 312b prior to either one of contacts 392a and 392b being accessible to a user (e.g., a user external to interior space 369).

Moreover, if a break event were able to pull adapter connector body 391 out from, or at least partially out from, interior space 369 in the direction of arrow PE (e.g., as shown in FIG. 29), no portion of contact 392a or of contact 392b of connector 390 would not be pulled along with adapter connector body 391. Instead, as described, each one of contacts 392a and 392b may be locked with respect to adapter connector body 391 (e.g., using one or more contact retention features 394af and one or more contact retention features 394bf). This may ensure that no portion of contact 392a or of contact 392b may remain electrically coupled to a respective one of contacts 312a and 312b (e.g., to remain hot/live if connector 310 plugged into socket connector 90) and, thus, potentially be accessible to a user when adapter connector body 391 may be pulled out from, or at least partially out from, interior space 369 in the direction of arrow PE. Therefore, unlike some embodiments where a protection body may not be provided and/or where contacts 392a and/or 392b of connector 390 may not be fixed with respect to adapter connector body 391 such that one or more portions of one or more of contacts 392a, 392b, 312a (e.g., within interior space 369 of outer shell 380), and 312b (e.g., within interior space 369 of outer shell 380) may be accessible to a user during such a break event while also being electrically coupled to socket connector 90 of electric power supply 91 (e.g., while at least a portion of contact 312a external to interior space 369 via slot 361a may be within and electrically coupled to socket connector contact 92a of socket connector 90 and/or while at least a portion of contact 312b external to interior space 369 via slot 361b may be within and electrically coupled to socket connector contact 92b of socket connector 90), thereby exposing the user to a dangerous condition, assembly 300 may protect a user during various potential break events. Thus, whether adapter connector assembly 391 is broken away from the remainder of assembly 300 and/or any portion of bottom wall structure 385 is broken by head portion 212th of contact connector mating structure 212c, no live contacts of assembly 300 may be touched or otherwise easily accessible (e.g., by a user).

An assembly (e.g., assembly 300) may be provided for being electrically coupled to a power supply contact (e.g., contact 92a) of a power supply (e.g., supply 91) and to a power adapter contact (e.g., contact 212a) of a power adapter (e.g., adapter 200). The assembly may include an outer case (e.g., shell 380) defining an interior space (e.g., space 369), wherein the outer case may include a five-sided box (e.g., walls 362/364/385/366a/366b) with an open end (e.g., opening 367). The assembly may also include a power supply connector (e.g., connector 310) including a power supply connector contact (e.g., contact 312a) including a power supply contact portion (e.g., tip 313a) operative to be electrically coupled to the power supply contact of the power supply, and a power adapter connector contact portion (e.g., extension 316ae or extension 316ai) positioned within the interior space. The assembly may also include a power adapter connector (e.g., connector 390) including a power adapter connector body (e.g., body 391) defining a contact passageway (e.g., passageway 393a) and operative to be held with respect to the outer case, wherein, when the power adapter connector body is held with respect to the outer case, a portion (e.g., structure 393 and/or structure 394) of the power adapter connector body may be positioned within the open end of the outer case, and a power adapter connector contact (e.g., contact 392a) at least partially positioned within the contact passageway and including a power adapter contact portion (e.g., portion 392at) operative to be electrically coupled to the power adapter contact of the power adapter, and a power supply connector contact portion (e.g., arm 392are or arm 392ari), wherein, when the power adapter connector body is held with respect to the outer case, the power supply connector contact portion may be electrically coupled to the power adapter connector contact portion within the interior space. The five-sided box may be a unibody structure. The outer case may not include a welded joint between any sides of the five-sided box. The outer case may include a first outer case structure (e.g., structure portion 360) and a second outer case structure (e.g., structure portion 370), wherein the first outer case structure and the second outer case structure together may provide a unibody structure. A portion (e.g., wall 365) of the first outer case structure and a portion (e.g., wall 375) of the second outer case structure may define different portions of a side (e.g., wall 385) of the five-sided box. The second outer case structure and the portion of the power adapter connector body may be the same color, and/or the first outer case structure and the second outer case structure may be different colors. A side (e.g., wall 385) of the five-sided box that is adjacent to the open end may include a slot (e.g., slot 385c) that may provide access to the interior space. The slot may be operative to retain a portion of a connector mating structure (e.g., structure 212c) of the power adapter within the interior space when the power adapter contact portion of the power adapter connector contact of the assembly is electrically coupled to the power adapter contact of the power adapter. The assembly may also include a spring (e.g., spring 350), wherein, when the power adapter connector body is held with respect to the outer case, at least a portion of the spring may be held within the interior space, and, when the power adapter connector body is held with respect to the outer case and when a base portion (e.g., portion 212cb) of a connector mating structure (e.g., structure 212c) extending from a surface (e.g., surface 211c) of the power adapter is positioned within the slot (e.g., slot 385c), a head portion (e.g., portion 212ch) of the connector mating structure coupled to the base portion of the connector mating structure may be is forced against a surface (e.g., surface 395) of the power adapter connector body within the interior space by the spring. At least a portion of the spring may be held within the interior space between the surface of the power adapter connector body and a surface (e.g., surface 375s) of the side (e.g., wall 385) of the five-sided box. The spring may be operative to force a surface (e.g., surface 385e) of the side (e.g., wall 385) of the five-sided box against the surface of the power adapter when the power adapter connector body is held with respect to the outer case and when the base portion of a connector mating structure (e.g., structure 212c) extending from a surface (e.g., surface 211c) of the power adapter is positioned within the slot. The assembly may also include a protection body (e.g., body 340), wherein the protection body may define at least a portion of a recess guide (e.g., guide 344age or guide 344agi) extending away from the open end of the five-sided box between a first recess guide end and a second recess guide end within the interior space, and the power adapter connector contact portion may be positioned within the interior space adjacent the second recess guide end of the recess guide, wherein the recess guide may be operative to prevent a user of the assembly from directly contacting the power adapter connector contact portion positioned within the interior space. The power adapter connector body may include a contact retention feature (e.g., feature 394af) external to the contact passageway, and the power adapter connector contact may also include a power adapter connector contact body (e.g., extender 392ax) held by the contact retention feature for retaining the power adapter connector contact at least partially within the contact passageway when the portion of the power adapter connector body is pulled out from within the open end of the outer case (e.g., in the direction of arrow PE).

An assembly (e.g., assembly 300) may be provided for being electrically coupled to a power supply contact (e.g., contact 92a) of a power supply (e.g., supply 91) and to a power adapter contact (e.g., contact 212a) of a power adapter (e.g., adapter 200). The assembly may include an outer case (e.g., shell 380) defining an interior space (e.g., space 369). The assembly may also include a power supply connector (e.g., connector 310) including a power supply connector contact (e.g., contact 312a) including a power supply contact portion (e.g., portion 313a) operative to be electrically coupled to the power supply contact of the power supply, and a power adapter connector contact portion (e.g., portion 316ae or portion 316ai) positioned within the interior space. The assembly may also include a power adapter connector (e.g., connector 390) including a power adapter connector body (e.g., body 391) defining a contact passageway (e.g., passageway 393a) and operative to be held with respect to the outer case, and a power adapter connector contact (e.g., contact 392a) at least partially positioned within the contact passageway and including a power adapter contact portion (e.g., portion 392at) operative to be electrically coupled to the power adapter contact of the power adapter, and a power supply connector contact portion (e.g., portion 392are or portion 392ari), wherein, when the power adapter connector body is held with respect to the outer case, the power supply connector contact portion may be electrically coupled to the power adapter connector contact portion within the interior space, structure (e.g., structure 344 and/or wall 362) within the interior space may define at least a portion of a recess guide (e.g., guide 344age or guide 344agi) extending between a first recess guide end and a second recess guide end within the interior space, the power adapter connector contact portion may be positioned within the interior space adjacent the second recess guide end of the recess guide, and the recess guide may be operative to prevent a user of the assembly from directly contacting the power adapter connector contact portion of the power supply connector contact positioned within the interior space. The assembly may also include a protection body (e.g., body 340) that may be physically fixed with respect to the outer case, wherein the protection body may include at least a portion (e.g., portion 344) of the structure. The protection body may include a first portion (e.g., portion 344) of the structure and the outer case may include a second portion (e.g., wall 362) of the structure. The assembly may also include a spring (e.g., spring 330) that may include a spring body (e.g., body 332) extending between a free spring end (e.g., end 339) and a fixed spring end (e.g., end 331) that may be physically fixed with respect to a portion of the protection body, and a bridge (e.g., bridge 320), wherein the bridge may be physically fixed with respect to a contact bridge portion (e.g., portion 315a) of the power supply connector, a spring surface (e.g., surface 328) of the bridge may physically contact a bridge surface (e.g., surface 338) of the spring body, and the spring may be configured to force the spring surface to stabilize at only one of the following two positions absent any forces external to the assembly: a first position at which the spring surface physically contacts a first portion (e.g., portion 338o) of the bridge surface when the power supply connector contact is in an open position with respect to the outer case and a second position at which the spring surface physically contacts a second portion (e.g., portion 338c) of the bridge surface when the power supply connector contact is in a closed position with respect to the outer case (380).

An assembly (e.g., assembly 300) may be provided for being electrically coupled to a power supply contact (e.g., contact 92a) of a power supply (e.g., supply 91) and to a power adapter contact (e.g., contact 212a) of a power adapter (e.g., adapter 200). The assembly may include an outer case (e.g., shell 380) defining an interior space (e.g., space 369). The assembly may also include a power supply connector (e.g., connector 310) including a power supply connector contact (e.g., contact 312a) that may include a power supply contact portion (e.g., portion 313a) operative to be electrically coupled to the power supply contact of the power supply and a power adapter connector contact portion (e.g., portion 316ae or portion 316ai) positioned within the interior space. The assembly may also include a power adapter connector (e.g., connector 390) including a power adapter connector body (e.g., body 391) that may define a contact passageway (e.g., passageway 393a), include a contact retention feature (e.g., feature 394af) external to the contact passageway, and be operative to be held with respect to the outer case, and a power adapter connector contact (e.g., contact 392a) at least partially positioned within the contact passageway and including a power adapter contact portion (e.g., portion 392at) operative to be electrically coupled to the power adapter contact of the power adapter, a power supply connector contact portion (e.g., portion 392are or portion 392ari) that is electrically coupled to the power adapter connector contact portion within the interior space when the power adapter connector body is held with respect to the outer case, and a power adapter connector contact body (e.g., portion 392ax) held by the contact retention feature for maintain the position of the power adapter connector contact at least partially within the contact passageway when the power adapter connector body is pulled away from the interior space while the power supply connector contact portion is electrically coupled to the power adapter connector contact portion within the interior space.

While there have been described power supply connector assemblies and methods for making the same, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “up” and “down,” “front” and “back” and “rear,” “exterior” and “interior,” “top” and “bottom” and “side,” “length” and “width” and “depth,” “thickness” and “diameter” and “cross-section” and “longitudinal,” “X-” and “Y-” and “Z-,” and the like may be used herein only for convenience, and that no fixed or absolute directional or orientational limitations are intended by the use of these words.

Therefore, those skilled in the art will appreciate that the invention can be practiced by other than the described embodiments, which are presented for purposes of illustration rather than of limitation.

What is claimed is:

1. An assembly for being electrically coupled to a power supply contact of a power supply and to a power adapter contact of a power adapter, the assembly comprising:
an outer case defining an interior space, wherein the outer case comprises a top wall, a bottom wall, a left wall, a right wall, a front wall, and an open end;
a power supply connector comprising:
a power supply connector contact comprising:
a power supply contact portion operative to be electrically coupled to the power supply contact of the power supply; and
a power adapter connector contact portion positioned within the interior space; and
a power adapter connector comprising:
a power adapter connector body defining a contact passageway and operative to be held with respect to the outer case, wherein, when the power adapter connector body is held with respect to the outer case, a portion of the power adapter connector body is positioned within the open end of the outer case; and
a power adapter connector contact at least partially positioned within the contact passageway and comprising:
a power adapter contact portion operative to be electrically coupled to the power adapter contact of the power adapter; and
a power supply connector contact portion, wherein, when the power adapter connector body is held with respect to the outer case, the power supply connector contact portion is electrically coupled to the power adapter connector contact portion within the interior space.

2. The assembly of claim 1, wherein the outer case is a unibody structure.

3. The assembly of claim 1, wherein the outer case does not comprise a welded joint between any walls of the outer case.

4. The assembly of claim 1, wherein the outer case comprises:
a first outer case structure; and
a second outer case structure, wherein the first outer case structure and the second outer case structure together provide a unibody structure.

5. The assembly of claim 4, wherein a portion of the first outer case structure and a portion of the second outer case structure define different portions of one of the walls of the outer case.

6. The assembly of claim 4, wherein the second outer case structure and the portion of the power adapter connector body are the same color.

7. The assembly of claim 6, wherein the first outer case structure and the second outer case structure are different colors.

8. The assembly of claim 1, wherein a wall of the outer case that is adjacent to the open end comprises a slot that provides access to the interior space.

9. The assembly of claim 8, wherein the slot is operative to retain a portion of a connector mating structure of the power adapter within the interior space when the power adapter contact portion of the power adapter connector contact of assembly is electrically coupled to the power adapter contact of the power adapter.

10. The assembly of claim 8, further comprising a spring, wherein:
when the power adapter connector body is held with respect to the outer case, at least a portion of the spring is held within the interior space; and
when the power adapter connector body is held with respect to the outer case and when a base portion of a connector mating structure extending from a surface of the power adapter is positioned within the slot, a head portion of the connector mating structure coupled to the base portion of the connector mating structure is forced against a surface of the power adapter connector body within the interior space by the spring.

11. The assembly of claim 10, wherein the at least a portion of the spring is held within the interior space between the surface of the power adapter connector body and a surface of the wall of the outer case.

12. The assembly of claim 10, wherein the spring is operative to force a surface of the wall of the outer case against the surface of the power adapter when the power adapter connector body is held with respect to the outer case and when the base portion of a connector mating structure extending from a surface of the power adapter is positioned within the slot.

13. The assembly of claim 1, further comprising a protection body, wherein:
the protection body defines at least a portion of a recess guide extending away from the open end of the outer case between a first recess guide end and a second recess guide end within the interior space; and
the power adapter connector contact portion is positioned within the interior space adjacent the second recess guide end of the recess guide.

14. The assembly of claim 13, wherein the recess guide is operative to prevent a user of assembly from directly contacting the power adapter connector contact portion positioned within the interior space.

15. The assembly of claim 1, wherein:
the power adapter connector body comprises a contact retention feature external to the contact passageway; and
the power adapter connector contact further comprises a power adapter connector contact body held by the contact retention feature for retaining the power adapter connector contact at least partially within the contact passageway when the portion of the power adapter connector body is pulled out from within the open end of the outer case.

16. An assembly for being electrically coupled to a power supply contact of a power supply and to a power adapter contact of a power adapter, the assembly comprising:
an outer case defining an interior space;
a power supply connector comprising:
a power supply connector contact comprising:
a power supply contact portion operative to be electrically coupled to the power supply contact of the power supply; and
a power adapter connector contact portion positioned within the interior space;
a power adapter connector comprising:
a power adapter connector body defining a contact passageway and operative to be held with respect to the outer case; and
a power adapter connector contact at least partially positioned within the contact passageway and comprising:
a power adapter contact portion operative to be electrically coupled to the power adapter contact of the power adapter; and
a power supply connector contact portion, wherein:
when the power adapter connector body is held with respect to the outer case, the power supply connector contact portion is electrically coupled to the power adapter connector contact portion within the interior space;
structure within the interior space defines at least a portion of a recess guide extending between a first recess guide end and a second recess guide end within the interior space;
the power adapter connector contact portion is positioned within the interior space adjacent the second recess guide end of the recess guide; and
the recess guide is operative to prevent a user of assembly from directly contacting the power adapter connector contact portion of the power supply connector contact positioned within the interior space.

17. The assembly of claim 16, further comprising a protection body physically fixed with respect to the outer case, wherein the protection body comprises at least a portion of the structure.

18. The assembly of claim 17, wherein:
the protection body comprises a first portion of the structure; and
the outer case comprises a second portion of the structure.

19. The assembly of claim 17, further comprising:
a spring that comprises a spring body extending between a free spring end and a fixed spring end that is physically fixed with respect to a portion of the protection body; and
a bridge, wherein:
the bridge is physically fixed with respect to a contact bridge portion of the power supply connector contact;
a spring surface of the bridge physically contacts a bridge surface of the spring body; and
the spring is configured to force the spring surface to stabilize at only one of the following two positions absent any forces external to the assembly:
a first position at which the spring surface physically contacts a first portion of the bridge surface when the power supply connector contact is in an open position with respect to the outer case; and
a second position at which the spring surface physically contacts a second portion of the bridge surface when the power supply connector contact is in a closed position with respect to the outer case.

20. An assembly for being electrically coupled to a power supply contact of a power supply and to a power adapter contact of a power adapter, the assembly comprising:
an outer case defining an interior space;
a power supply connector comprising:
a power supply connector contact comprising:
a power supply contact portion operative to be electrically coupled to the power supply contact of the power supply; and
a power adapter connector contact portion positioned within the interior space;
a power adapter connector comprising:
a power adapter connector body, wherein the power adapter connector body:
defines a contact passageway;
comprises a contact retention feature external to the contact passageway; and
is operative to be held with respect to the outer case; and
a power adapter connector contact at least partially positioned within the contact passageway and comprising:
a power adapter contact portion operative to be electrically coupled to the power adapter contact of the power adapter;
a power supply connector contact portion that is electrically coupled to the power adapter connector contact portion within the interior space when the power adapter connector body is held with respect to the outer case; and
a power adapter connector contact body held by the contact retention feature for maintaining the position of the power adapter connector contact at least partially within the contact passageway when the power adapter connector body is pulled away from the interior space while the power supply connector contact portion is electrically coupled to the power adapter connector contact portion within the interior space.
